(19) United States
(12) Patent Application Publication
(10) Pub. No.: US 2013/0177787 A1
(43) Pub. Date: Jul. 11, 2013

(54) CURRENT COLLECTOR AND NONAQUEOUS SECONDARY BATTERY

(71) Applicants: Satoshi ARIMA, Osaka (JP); Naoto TORATA, Osaka (JP); Satomi HASEGAWA, Osaka (JP)

(72) Inventors: Satoshi ARIMA, Osaka (JP); Naoto TORATA, Osaka (JP); Satomi HASEGAWA, Osaka (JP)

(73) Assignee: SHARP KABUSHIKI SAISHA, OSAKA (JP)

(21) Appl. No.: 13/535,806

(22) Filed: Jun. 28, 2012

(30) Foreign Application Priority Data
Jul. 1, 2011 (JP) 2011-147529

(51) Int. Cl. H01M 2/34

(52) U.S. Cl. CPC H01M 2/348
USPC 429/62

(57) ABSTRACT

A current collector comprising: a folded region in which an end part of a multi-layered structure having an insulation layer sandwiched by electrically conductive layers is folded at least twice in the same direction; the electrically conductive layers sandwiching the insulation layer being electrically connected to each other in the folded region; and inside surfaces of the end part of the current collector forming the folded region being either separated from each other or partially in contact with each other.

This application is based on Japanese Patent Application No. 2011-147529 filed on Jul. 1, 2011, the contents of which are hereby incorporated by reference.

### BACKGROUND OF THE INVENTION

1. Field of the Invention

The present invention relates to a current collector and a nonaqueous secondary cell, and particularly relates to a current collector having an insulation layer and a nonaqueous secondary cell that uses this current collector.

2. Description of the Prior Art

Nonaqueous secondary cells, typified by lithium ion secondary cells, have high capacity and high energy density, and have excellent characteristics such as storage performance and the ability to repeatedly charge and discharge electricity. Nonaqueous secondary cells are therefore widely utilized in portable appliances and other consumer appliances. In recent years, because of the rise in awareness relating to environmental problems and energy conservation, lithium ion secondary cells have come to be utilized in power storage applications and onboard applications in electric automobiles and the like.

Because of the high energy density of nonaqueous secondary cells, they have a high risk of abnormal heat generation, igniting, and other mishaps when exposed to an overcharged state or a high-temperature environment. Therefore, various countermeasures pertaining to safety have been taken with nonaqueous secondary cells.

Conventionally, there have been proposed lithium ion secondary cells that use a current collector having a multi-layered structure in order to prevent ignition due to abnormal heat generation (see Patent Document 1, for example).

Patent Document 1 proposes a lithium ion secondary cell that uses a current collector in which a metal layer is formed on both sides of a resin film (an insulation layer) having a low melting point of 130 to 170° C. When abnormal heat generation occurs in an overcharged state, a high-temperature state, or other state in this lithium ion secondary cell, the low-melting-point resin film melts. The electrodes fail due to the melting of the resin film. The electric current is thereby cut, the increase in temperature of the cell interior is therefore suppressed, and ignition is prevented.

Patent Document 1: Japanese Laid-open Patent Application No. 11-102711

As described above, the current collector proposed in Patent Document 1 is extremely effective as a safety countermeasure of a nonaqueous secondary cell.

However, since the above-described current collector has a configuration in which a metal layer is formed on both sides of the insulating resin film, a stacked nonaqueous secondary cell in which a plurality of electrodes are stacked, for example, is subject to an inconvenience in that electrical conduction among the electrodes cannot be established when a tab electrode used as a wiring lead is connected to the current collector. Specifically, there is an inconvenience in that it is difficult to electrically connect the tab electrode with all the electrodes. This is a problem in that cell performance decreases significantly.

### SUMMARY OF THE INVENTION

The present invention was devised in order to resolve objects such as the one described above, it being one object of the invention to provide a current collector and a nonaqueous secondary cell capable of suppressing decreases in cell performance while improving safety.

To achieve the object described above, the current collector according to a first aspect of the invention is a current collector having a multi-layered structure having an insulation layer sandwiched by electrically conductive layers, the current collector having a folded region in which an end part is folded at least twice in the same direction, and the electrically conductive layers sandwiching the insulation layer being electrically connected to each other in the folded region. Inside surfaces of the end part of the current collector forming the folded region are either separated from each other or partially in contact with each other.

In the current collector according to the first aspect, due to the folded region where the current collector end part is folded at least twice in the same direction being provided as described above, the electrically conductive layers sandwiching the insulation layer can be electrically connected to each other in the folded region. Therefore, electrical conduction among the electrodes (among the electrically conductive layers) can be established by forming the electrodes using such a current collector. Decreases in cell performance can thereby be suppressed.

In the first aspect, the inside surfaces of the current collector end part forming the folded region described above are either separated from each other or partially in contact with each other. In other words, the inside surfaces of the current collector end part forming the folded region are not entirely in contact with each other. Therefore, the load applied to the folded portion (the folded region) of the current collector can be reduced when the current collector end part is folded. The occurrence of cracks, ruptures, and the like in the electrically conductive layers of the current collector can thereby be suppressed. Specifically, the electrically conductive layers of the current collector can be protected. As a result, it is possible to suppress the inconvenience of decreased electrical conductivity in the folded region resulting from the occurrence of cracks, ruptures, and the like, and the current collecting performance in the current collector can therefore be improved.

Furthermore, in the first aspect, due to the current collector being configured in a multi-layered structure as described above, the insulation layers of the current collector melt and the electrode fails when abnormal heat generation occurs in states such as overcharging or high temperatures, for example, and the electric current can therefore be cut. Temperature increases in the cell interior can thereby be suppressed, and the occurrence of ignition and other abnormal states can therefore be prevented.

In the current collector according to the first aspect described above, a spacer contacting the inside surfaces of the folded region is also preferably provided. With such a configuration, a state in which the inside surfaces of the current collector end part forming the folded region are not entirely in contact with each other can easily be brought about. The current collecting performance of the current collector can thereby be easily improved.

In this case, the spacer is preferably an electrical conductor. With such a configuration, the contact surface area and contact strength of the electrically conducting locations can be increased by the malleability of the spacer, and the contact resistance between the electrically conductive layers sandwiching the insulation layer can therefore be reduced. Therefore, the current collecting performance of the current collector can be effectively improved. Additionally, the spacer can be easily fixed to the inside surfaces (the electrically conductive layers) of the folded region. In terms of long-term reliability, the electrical conductor is preferably one having superior malleability, and is more preferably the same material as the members placed in the cell interior.

A nonaqueous secondary cell according to a second aspect of the invention comprises an electrode including the current collector according to the first aspect described above, and an active material layer formed in a region of the current collector excluding the folded region; and a tab electrode electrically connected with the electrode. The tab electrode described above is fixed by welding to the folded region of the current collector.

In the nonaqueous secondary cell according to the second aspect, electrical conduction among the electrodes can be established by forming the electrodes using the current collector according to the first aspect, and the tab electrode can therefore be electrically connected with all of the electrodes. Additionally, the current collecting performance in the current collector can be improved. Decreases in cell performance can thereby be suppressed, and the nonaqueous secondary cell can therefore be put into practical application with maximum performance.

In the second aspect, the welding strength can easily be improved by fixing the tab electrode by welding to the folded region of the current collector. Vibration resistance can thereby be improved, and the deterioration over time of the cell performance can therefore be suppressed.

In the second aspect, the ignition and other abnormal states can be prevented by forming the electrode using the current collector having the insulation layer, and safety can therefore be better improved.

In the nonaqueous secondary cell according to the second aspect described above, the thickness of the folded region in the electrode is preferably greater than the thickness of the region where the active material layer is formed. With such a configuration, warping can be reduced between the folded region and the region where the active material layers are formed, and the load applied to the region between the folded region and the region where the active material layers are formed can therefore be reduced. The application of loads caused by vibration can also be impeded by reducing warping of the electrode, and vibration resistance can therefore be improved.

In this case, the tab electrode is preferably fixed by welding so as to mesh with the current collector. With such a configuration, the welding strength can be increased. Therefore, decreases in welding strength between the folded region and the tab electrode can be suppressed even when the folded region is formed in the current collector; therefore, welding resistance can be reduced and vibration resistance can be improved.

The nonaqueous secondary cell according to the second aspect described above preferably further comprises a through-member configured from an electrically conductive material and passing through the folded region of the current collector in the thickness direction. With such a configuration, the electrically conductive layers sandwiching the insulation layer can be electrically connected to each other by the through-member as well. Electrical conduction among the electrodes can thereby be established, and decreases in cell performance can therefore be further suppressed. Stacked folded regions can also be more strongly connected and fixed together, and vibration resistance can also be improved.

In the nonaqueous secondary cell according to the second aspect described above, preferably, the electrode includes a cathode and an anode, and the cathode and/or the anode is formed using the current collector having a multi-layered structure. With such a configuration, the safety of the nonaqueous secondary cell can be effectively improved.

In the above-described configuration having the cathode and the anode, the electrically conductive layers of the current collector in the cathode are preferably configured from aluminum when the cathode is formed using the above-described current collector having a multi-layered structure. The electrically conductive layers of the current collector in the anode are also preferably configured from copper when the anode is formed using the above-described current collector having a multi-layered structure.

As described above, according to the present invention, a nonaqueous secondary cell capable of suppressing decreases in cell performance while improving safety can be easily obtained.

### BRIEF DESCRIPTION OF THE DRAWINGS

FIG. 1 is an exploded perspective view of the lithium ion secondary cell according to the first embodiment of the present invention;

FIG. 2 is an exploded perspective view of the electrode group of the lithium ion secondary cell according to the first embodiment of the present invention;

FIG. 3 is an overall perspective view of the lithium ion secondary cell according to the first embodiment of the present invention;

FIG. 4 is a schematic cross-sectional view showing an enlargement of part of a cathode current collector of the lithium ion secondary cell according to the first embodiment of the present invention;

FIG. 5 is a cross-sectional view (a view corresponding to part of a cross section along line A-A of FIG. 7) of a cathode of the lithium ion secondary cell according to the first embodiment of the present invention;

FIG. 6 is a plan view of the cathode of the lithium ion secondary cell according to the first embodiment of the present invention;

FIG. 7 is a perspective view of the cathode of the lithium ion secondary cell according to the first embodiment of the present invention;

FIG. 8 is a schematic cross-sectional view (a drawing showing a state in which a spacer has been placed) showing an enlargement of part of the cathode current collector of the lithium ion secondary cell according to the first embodiment of the present invention;

FIG. 9 is a perspective view showing the spacer used in the lithium ion secondary cell according to the first embodiment of the present invention;

FIG. 10 is a cross-sectional view schematically showing part of the electrode group of the lithium ion secondary cell according to the first embodiment of the present invention;

FIG. 11 is a schematic cross-sectional view showing the current collector and the tab electrode in a state of having been fixed by welding in the first embodiment of the present invention;

FIG. 12 is a schematic cross-sectional view along line C1-C1 of FIG. 11;

FIG. 13 is a cross-sectional view (a view corresponding to the cross section along line B-B of FIG. 15) of an anode of the lithium ion secondary cell according to the first embodiment of the present invention;

FIG. 14 is a plan view of the anode of the lithium ion secondary cell according to the first embodiment of the present invention;

FIG. 15 is a perspective view of the anode of the lithium ion secondary cell according to the first embodiment of the present invention;

FIG. 16 is a plan view of a separator of the lithium ion secondary cell according to the first embodiment of the present invention;

FIG. 17 is a schematic cross-sectional view showing an enlargement of part of a cathode current collector according to the second embodiment of the present invention;

FIG. 18 is a schematic cross-sectional view showing the cathode current collector and the tab electrode in a state of having been fixed by welding in the second embodiment of the present invention;

FIG. 19 is schematic cross-sectional view along line C2-C2 of FIG. 18;

FIG. 20 is a schematic cross-sectional view showing an enlargement of part of a cathode current collector of the lithium ion secondary cell according to the first modification of the second embodiment;

FIG. 21 is a schematic cross-sectional view showing an enlargement of part of a cathode current collector of the lithium ion secondary cell according to the second modification of the second embodiment;

FIG. 22 is a plan view schematically showing part of a cathode used in the lithium ion secondary cell according to the third embodiment of the present invention; and

FIG. 23 is a cross-sectional view schematically showing part of the electrode group of the lithium ion secondary cell according to the third embodiment of the present invention.

### DETAILED DESCRIPTION OF PREFERRED EMBODIMENTS

Embodiments that specify the present invention are described in detail hereinbelow based on the drawings, but the present invention is in no way limited by these embodiments. In the following embodiments, a case is described in which the present invention is applied to a stacked lithium ion secondary cell, one example of a nonaqueous secondary cell.

### First Embodiment

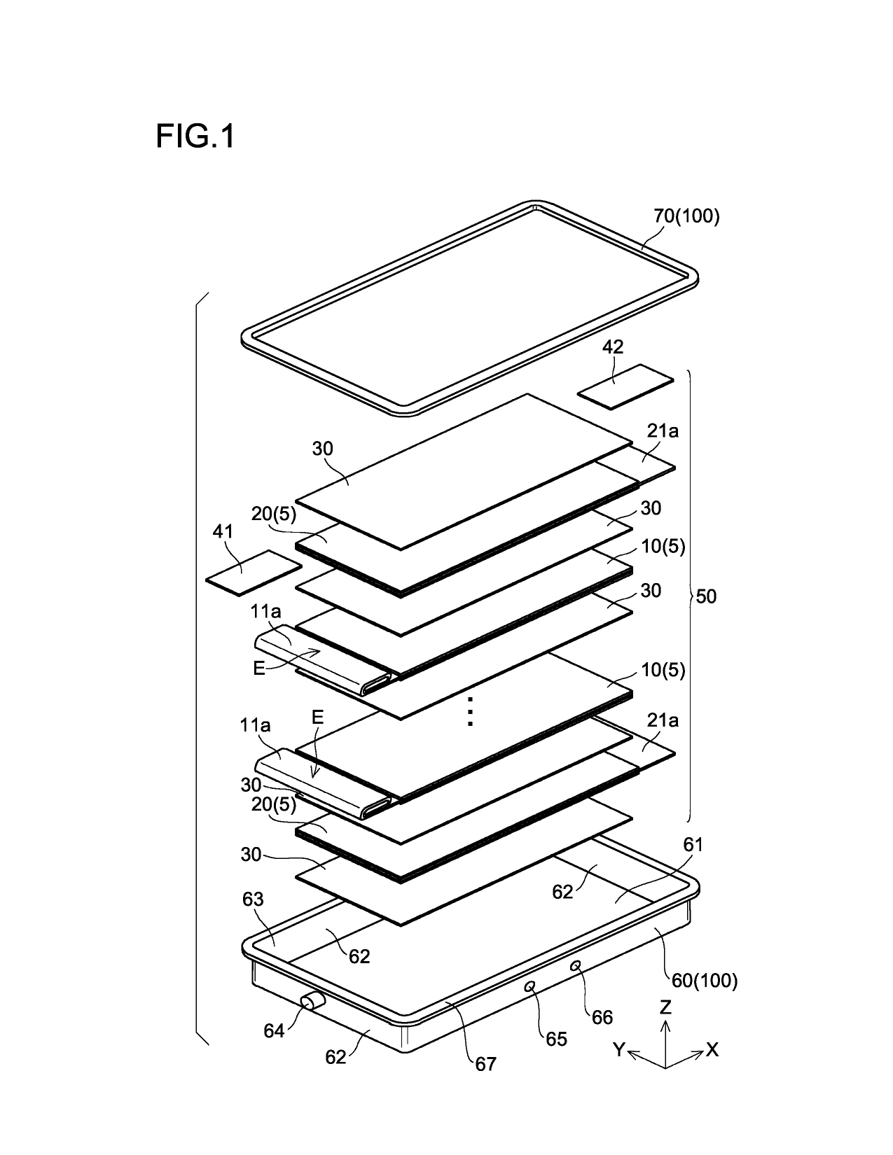

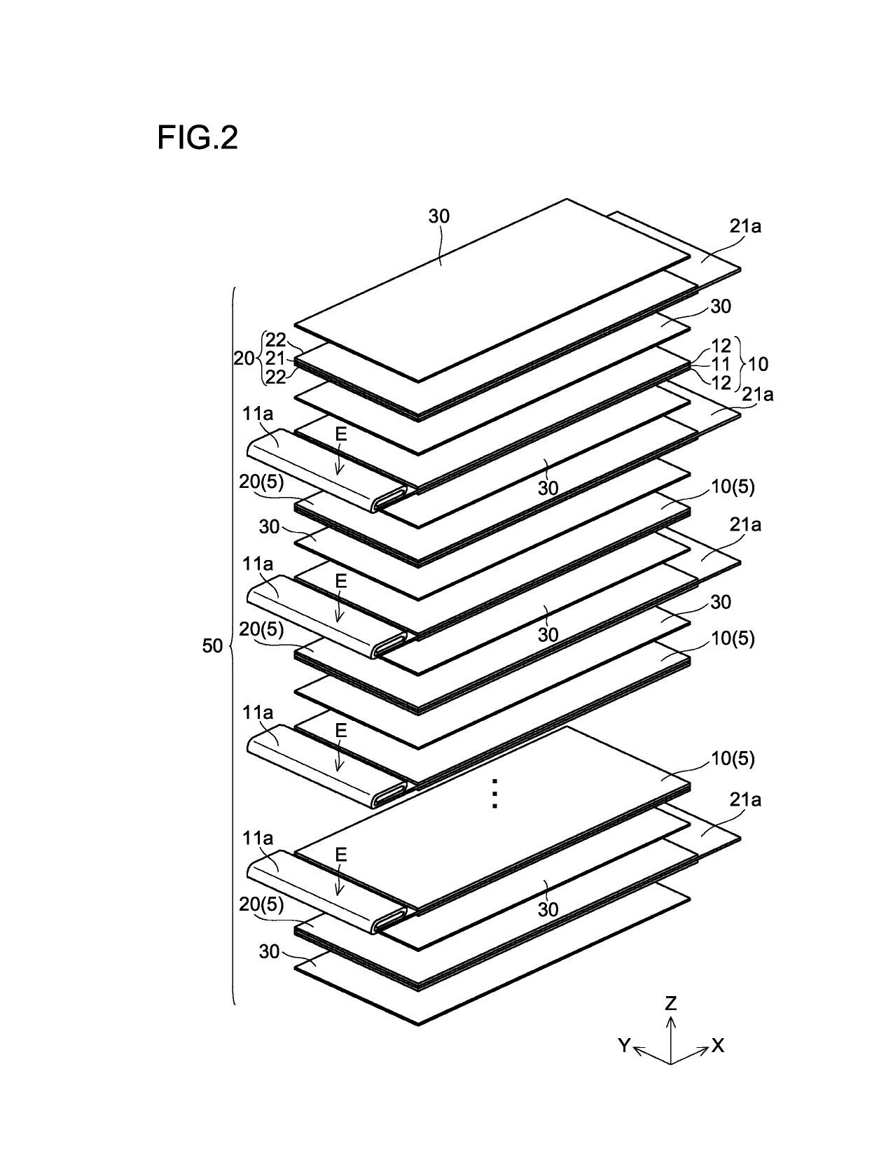

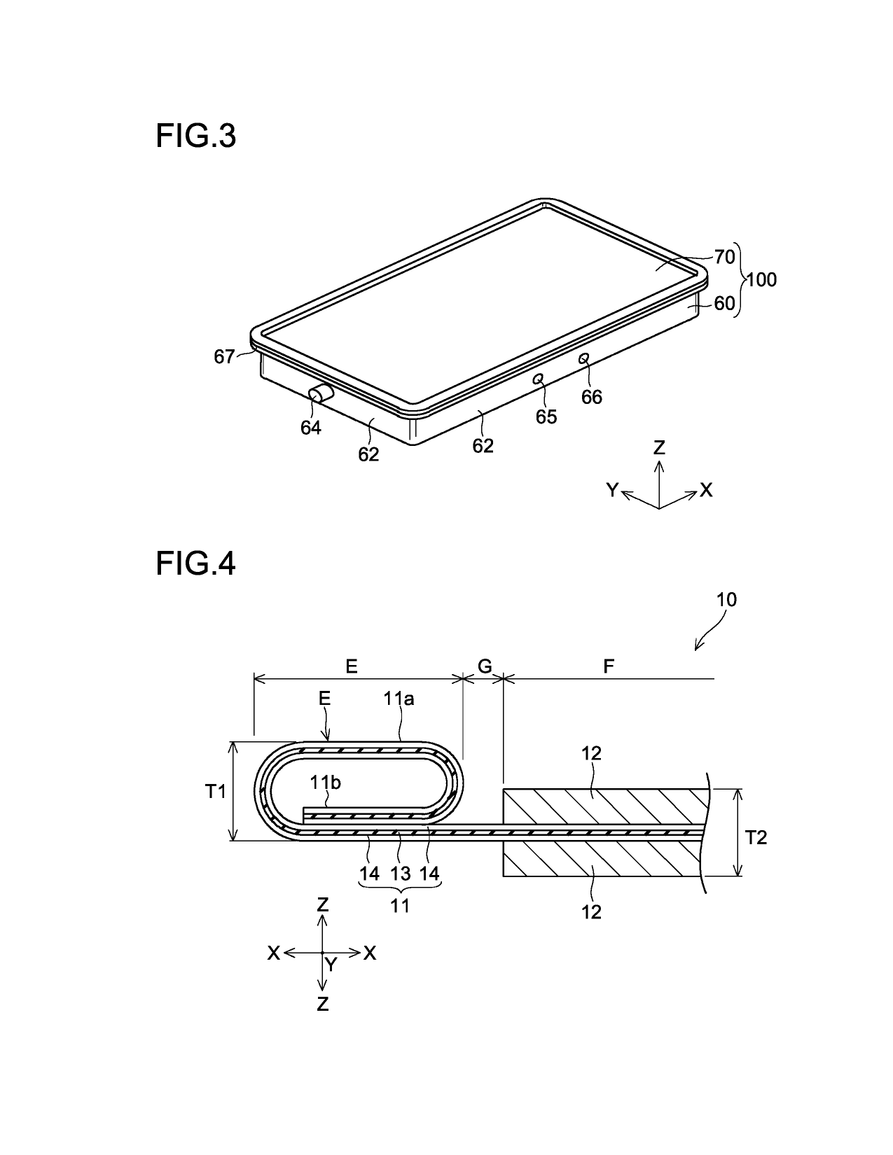

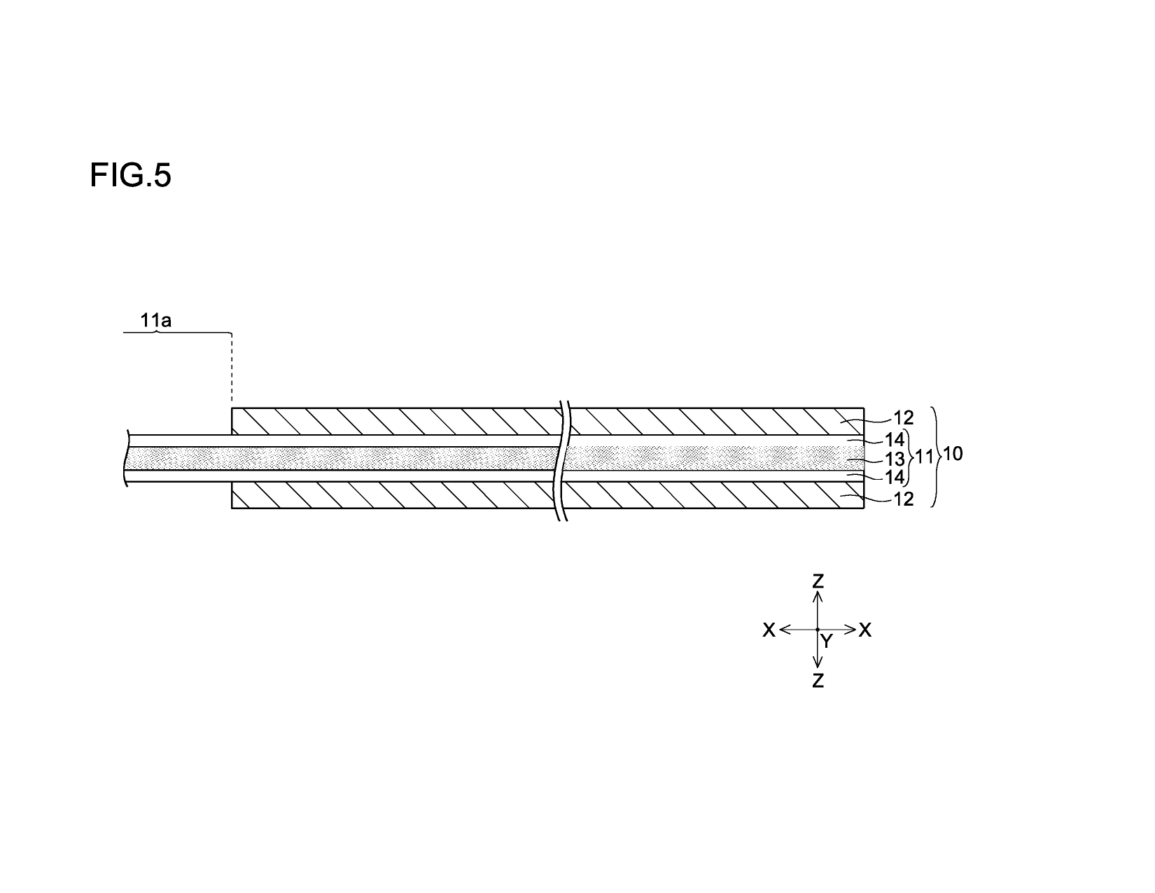

FIG. 1 is an exploded perspective view of a lithium ion secondary cell according to the first embodiment of the present invention. FIG. 2 is an exploded perspective view of an electrode group of the lithium ion secondary cell according to the first embodiment of the present invention. FIG. 3 is an overall perspective view of the lithium ion secondary cell according to the first embodiment of the present invention. FIG. 4 is a schematic cross-sectional view showing an enlargement of part of the cathode current collector of the lithium ion secondary cell according to the first embodiment of the present invention. FIGS. 5 through 16 are drawings for illustrating the lithium ion secondary cell according to the first embodiment of the present invention. First, the lithium ion secondary cell according to the first embodiment of the present invention will be described, referring to FIGS. 1 through 16.

The lithium ion secondary cell according to the first embodiment is a large secondary cell having a rectangular flat shape and comprising an electrode group 50 (see FIG. 1) including a plurality of electrodes 5, and a metal external container 100 for enclosing the electrode group 50 together with a nonaqueous electrolytic solution, as shown in FIGS. 1 and 3.

The electrodes 5 are configured including cathodes 10 and anodes 20, and between the cathodes 10 and anodes 20 are placed separators 30 for suppressing short circuiting of the cathodes 10 and the anodes 20, as shown in FIGS. 1 and 2. Specifically, the cathodes 10 and the anodes 20 are placed facing each other from opposite sides of the separators 30, and are configured into a stacked structure (stacked body) due to the cathodes 10, the separators 30, and the anodes 20 being stacked sequentially. The cathodes 10 and the anodes 20 are alternatively stacked one by one. The electrode group 50 described above is configured so that one cathode 10 is positioned between two adjacent anodes 20.

The electrode group 50 described above is configured including thirteen cathodes 10, fourteen anodes 20, and twenty-eight separators 30, for example, the cathodes 10 and the anodes 20 being alternatively stacked on opposite sides of the separators 30. Furthermore, the separators 30 are placed on the outermost sides in the electrode group 50 described above (the outer sides of the outermost layer anodes 20), providing insulation relative to the external container 100.

Each of the cathodes 10 constituting the electrode group 50 has a configuration in which cathode active material layers 12 are supported on both sides of a cathode current collector 11, as shown in FIGS. 4 and 5.

The cathode current collector 11 has the function of collecting the current of the cathode active material layers 12.

In the first embodiment, the cathode current collector 11 described above is configured into a multi-layered structure (three-layered structure) in which electrically conductive layers 14 are formed on both sides of an insulating resin layer 13. Therefore, the electrically conductive layers 14 are formed on both sides of the insulating resin layer 13. The resin layer 13 is one example of the “insulation layer” of the present invention.

The electrically conductive layers 14 constituting the cathode current collector 11 are configured from aluminum or an aluminum alloy, for example, and are formed into a thickness of approximately 2 to 15 μm. Aluminum can be used suitably as the electrically conductive layers 14 of the cathode current collector 11 because it passivates and becomes highly resistant to oxidation. The electrically conductive layers 14 described above may also be a material other than aluminum or an aluminum alloy, e.g., they may be configured from titanium, stainless steel, nickel or another metal material, an alloy of these metals, or the like.

The method for forming the electrically conductive layers 14 is not particularly limited; possible examples thereof include vapor deposition, sputtering, electroplating, electroless plating, attaching metal foil, or the like; and a method composed of a combination of these methods.

The resin layer 13 of the cathode current collector 11 is configured from a plastic material consisting of a thermoplastic resin. The resin layer 13 is composed of a sheet-shaped resin film, for example. Suitable examples that can be used as the thermoplastic resin constituting the plastic material include polyethylene (PE), polypropylene (PP) or another polyolefin resin, polystyrene (PS), polyvinyl chloride, polyamide, and the like, which have a heat distortion temperature of 150° C. or less. Preferred among these are polyethylene (PE), polypropylene (PP) or another polyolefin resin, polyvinyl chloride, and the like, which at 120° C. have a thermal shrinkage rate of 1.5% or more in any planar direction. Composite films thereof and resin films whose surfaces have been processed can also be suitably used. Furthermore, resin films of the same material as the separators 30 described above can also be used. When the resins have different heat distortion temperatures, thermal shrinkage rates, and other properties due to differences in their manufacturing steps and processing, the resins can be used in both the resin layer 13 and the separators 30. After the layered material constituting the insulation layer (the resin layer 13) is kept for a certain time duration at a certain temperature, the thermal shrinkage rate can be determined from the distance between two points measured before and after heat treatment. The heat distortion temperature is defined as the lowest temperature at which the thermal shrinkage rate is 10% or greater (heat distortion temperature<melting point).

In order to achieve a balance between improving energy density and maintaining strength in the secondary cell, the thickness of the resin layer 13 is preferably 5 μm or greater and 70 μm or less, and more preferably 10 μm or greater and 50 μm or less. The resin layer 13 (the resin film) may be a resin film manufactured by any method of uniaxial stretching, biaxial stretching, non-stretching, and the like. Instead of a film shape, the resin layer 13 of the cathode current collector 11 may also have a fibrous shape.

Instead of a foil, the regions in the cathode current collector 11 where the cathode active material layers 12 are formed may be in the form of a film, a sheet, a netting, a punched or expanded article, a lath, a porous body, a foamed body, a fiber cluster formation, or the like.

The cathode active material layers 12 are configured including a cathode active material that can occlude and discharge lithium ions. An oxide that contains lithium is a possible example of the cathode active material. Specifically, possible examples include LiCoO₂, LiFeO₂, LiMnO₂, LiMn₂O₄, and compounds in which some of the transition metals in these oxides are replaced with other metal elements. Of these it is preferable that the cathode active material be one that can utilize the 80% or more of the amount of lithium contained in the cathode in the cell reaction during normal use. It is thereby possible to increase the safety of the secondary cell in relation to overcharging and other accidents. Possible examples of such a cathode active material include compounds having a spinel structure such as LiMn₂O₄, compounds having an olivine structure expressed by LiₓMPO₄ (M being at least one element selected from Co, Ni, Mn, and Fe), and the like. Of these, a cathode active material containing Mn and/or Fe is preferable in terms of cost. Furthermore, it is preferable to use LiFePO₄ in terms of safety and charging voltage. LiFePO₄ is not susceptible to oxygen discharge by temperature increase because all of the oxygen (O) is bonded with the phosphorus by adamant covalent bonds. Therefore, LiFePO₄ has excellent safety.

The thickness of the cathode active material layers 12 described above is preferably about 20 μm to 2 mm, and more preferably about 50 μm to 1 mm.

When the cathode active material layers 12 described above include at least a cathode active material, the configuration thereof is not particularly limited. For example, other than the cathode active material, the cathode active material layers 12 may include an electrical conductor, a thickener, a binder, and other materials.

The electrical conductor is not particularly limited as long as it is an electronically conductive material that does not adversely affect the cell performance of the cathodes 10. Possible examples include: carbon black, acetylene black, ketjen black, graphite (natural graphite, synthetic graphite), carbon fibers, and other carbon materials; electrically conductive metal oxides; and the like. Of these, carbon black and acetylene black are preferable as the electrical conductor in terms of their electronic conductivity and coatability.

Possible examples of the thickener include polyethylene glycols, celluloses, polyacrylamides, poly N-vinyl amides, poly N-vinyl pyrrolidones, and the like. Of these, polyethylene glycols, carboxymethyl celluloses (CMC) and other celluloses, and the like are preferable as the thickener, and CMC is particularly preferable.

The binder fulfills the role of linking active material grains and electrical conductor grains, and possible examples thereof include: polyvinylidene fluoride (PVDF), polyvinyl pyridine, polytetrafluoroethylene, and other fluoropolymers; polyethylene, polypropylene, and other polyolefin-based polymers; styrene butadiene rubber, and the like.

Possible examples of the solvent for dispersing the cathode active material, the electrical conductor, and binder, and the like include N-methyl-2-pyrrolidone, dimethyl formamide, dimethyl acetamide, methyl ethyl ketone, cyclohexanone, methyl acetate, methyl acrylate, diethyl triamine, N,N-dimethylamino propylamine, ethylene oxide, tetrahydrofuran, and other organic solvents.

The cathodes 10 described above are formed by mixing the cathode active material, the electrical conductor, the thickener, and the binder, adding a suitable solvent to create a pasty cathode mixture, coating the surface of the cathode current collector 11 with the mixture, drying the coating, and compressing the result to increase the electrode density as necessary, for example.

In the first embodiment, the thickness T2 of the region where the cathode active material layers 12 are formed in the cathode 10 (the region F) is approximately 400 μm, for example, as shown in FIG. 4. When the thickness T2 of the region F where the cathode active material layers 12 are formed is less than 50 μm, the active material layers are too thin, and the energy density of the cell therefore decreases. When the thickness T2 of the region F described above is greater than 4000 μm, the active material layers are too thick, and the active material therefore has low electrode performance for its weight. Therefore, the thickness T2 of the region F described above is preferably 50 μm or greater and 4000 μm or less. The thickness T2 of the region F described above is more preferably 60 μm or greater and 1000 μm or less, and even more preferably 100 μm or greater and 600 μm or less.

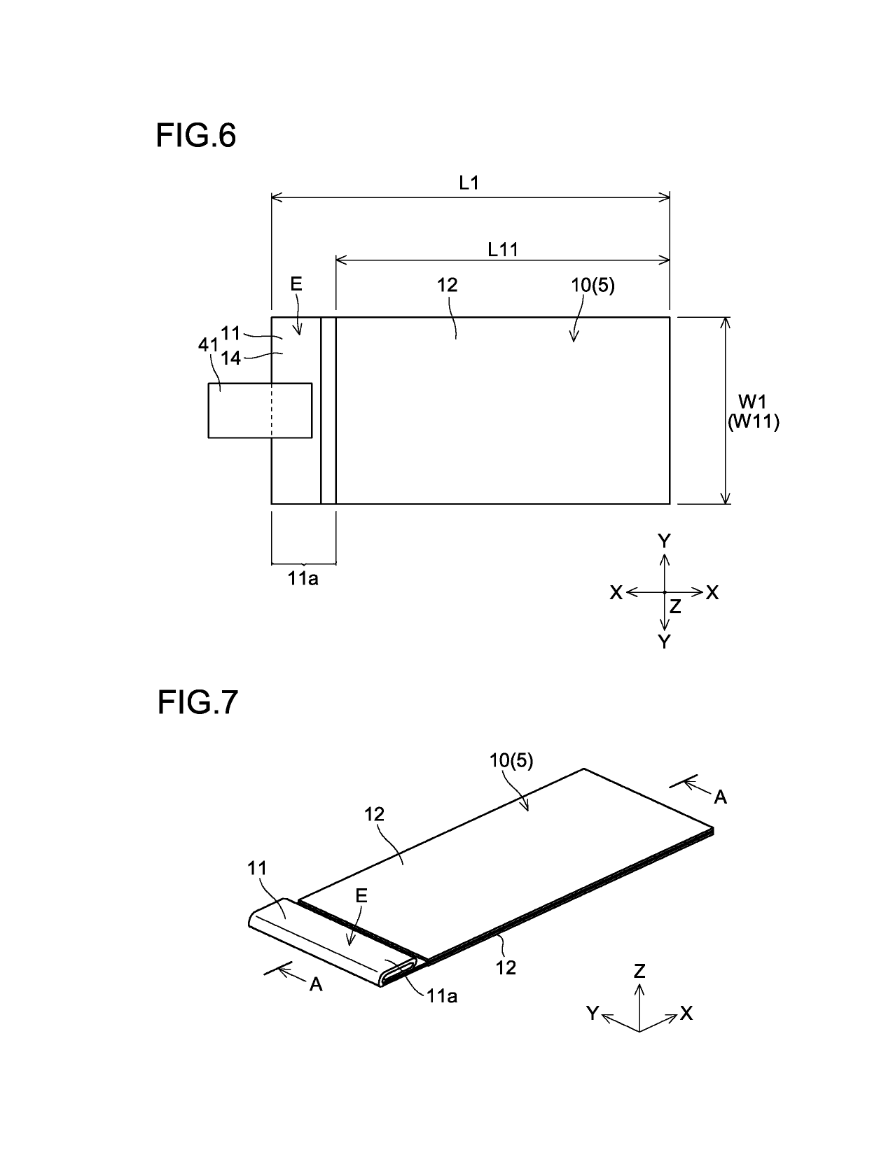

Each of the cathodes 10 described above, viewed in plan fashion, has a substantially rectangular shape as shown in FIG. 6. The width W1 of the cathode 10 described above in the Y direction is approximately 100 mm, for example, and the length L1 in the X direction is approximately 150 mm, for example. The coated region (formed region) of the cathode active material layers 12 has a width W11 in the Y direction equal to the width W1 of the cathode 10 at approximately 100 mm, for example, and a length L11 in the X direction of approximately 135 mm, for example.

The cathode 10 described above has, at one end in the X direction (the end part), a current collector exposed part (uncoated part) 11a where the cathode active material layers 12 are not formed (coated) and the surfaces (electrically conductive layers 14) of the cathode current collector 11 are exposed, as shown in FIGS. 6 and 7. A tab electrode 41 (see FIG. 6) for extracting electric current to the exterior is electrically connected to the current collector exposed part 11a. The tab electrode 41 is formed into a shape approximately 30 mm in width and approximately 70 mm in length, for example, with a thickness of about 100 μm, for example.

In the first embodiment, each of the cathodes 10 described above has a folded region E where the end part in which the cathode active material layers 12 are not formed is folded at least twice (e.g., twice) in the same direction, as shown in FIGS. 1, 2, and 4. Specifically, in the first embodiment, the end part of the current collector exposed part (the uncoated part) 11a in the cathode current collector 11 is folded at least twice in the same direction (towards the cathode active material layers 12). This folded region E is not folded exactly so as to form creases, but is folded in a manner such that the end part of the cathode current collector 11 is rolled. Therefore, the inside surfaces 1 lb of the end part of the cathode current collector 11 forming the folded region E are entirely not in contact with each other, as shown in FIG. 4. Therefore, the radius of curvature of the folded portion in the folded region E increases, and a space is formed inside the folded region E. The load acting on the folded portion of the cathode current collector 11 (particularly the curved surface regions of the folded region E) is thereby reduced. The length L1 (see FIG. 6) in the X direction of the cathode current collector 11 (the cathode 10) described above is the length in a state in which the folded region E has been formed. Therefore, the length in the direction of the cathode current collector 11 before the folded region E is longer than L1 (approximately 150 mm).

Since the folded region E described above is a region in which the end part of the cathode current collector 11 where the cathode active material layers 12 are not formed is folded at least twice in the same direction, the electrically conductive layers 14 sandwiching the resin layer 13 are electrically connected to each other in the folded region E. Specifically, the electrically conductive layer 14 on one side and the electrically conductive layer 14 on the other side in the cathode current collector 11 are electrically connected.

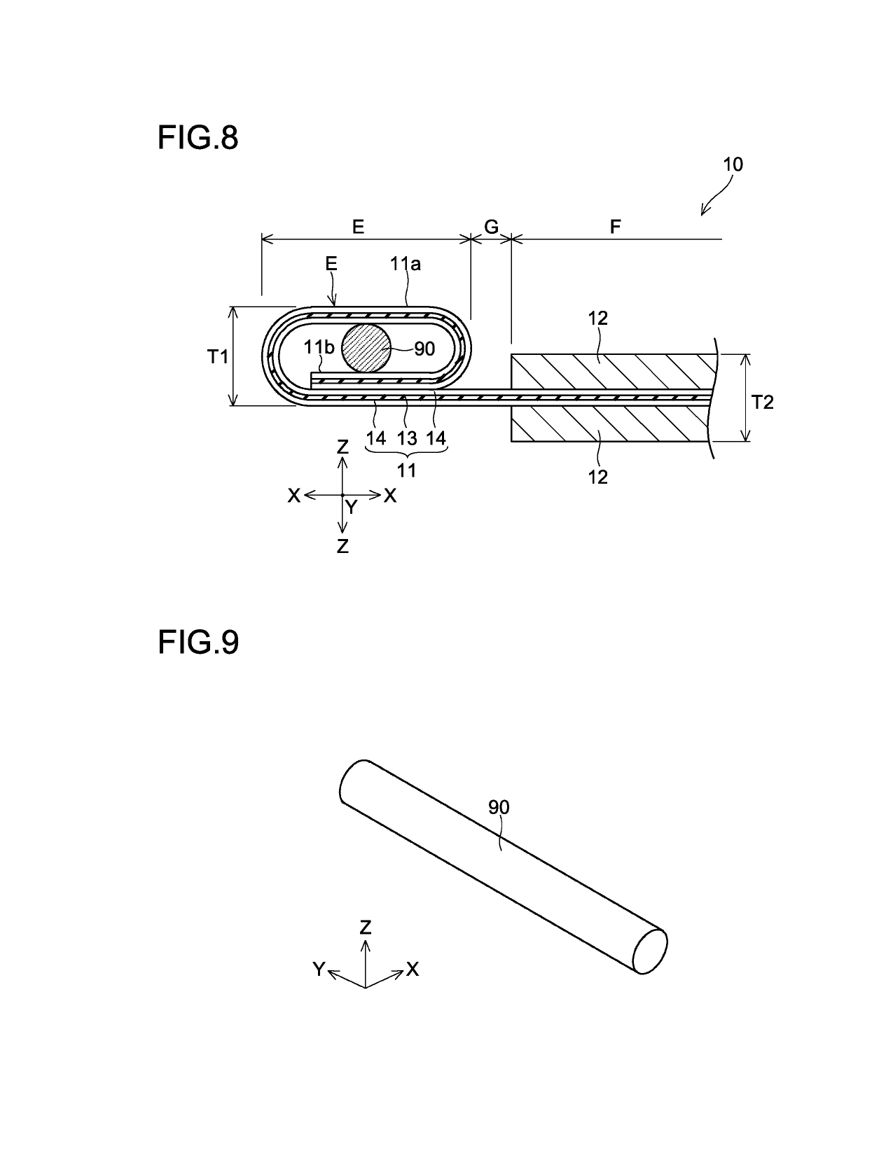

Furthermore, in the first embodiment, the inside surfaces 1 lb of the cathode current collector 11 where the folded region E is formed are separated from each other. In the first embodiment, a spacer 90 is placed in the interior of the folded region E as shown in FIG. 8. This spacer 90 is in contact with the inside surfaces 1 lb of the folded region E in the interior of the folded region E. The spacer 90 also has a function for keeping the shape of the folded region E. Furthermore, the spacer 90 is preferably composed of an electrical conductor having superior malleability, and is formed into a cylindrical shape, for example, as shown in FIG. 9. The spacer 90 described above is preferably configured from a metal material such as aluminum or titanium, an alloy of these metals, or the like. When the spacer 90 is placed in the anode current collector 21, the spacer 90 is preferably configured from a metal material such as copper, titanium, stainless steel, iron, or nickel; an alloy of these metals; or the like.

In the first embodiment, the thickness T1 of the folded region E is equal to or greater than the thickness T2 of the region F where the cathode active material layers 12 are formed (the thickness of the electrode), as shown in FIGS. 4 and 8. Specifically, in the first embodiment, the thickness T1 of the folded region E is approximately 850 μm, for example. When the thickness T1 of the folded region E is less than 50 μm, the strength is insufficient. On the other hand, when the thickness T1 of the folded region E is greater than 10000 μm, the current collecting part (the location connected to the tab electrode 41) becomes thick when stacked, making it difficult to produce the cell. Therefore, the thickness T1 of the folded region E is preferably 50 μm or greater and 10000 μm or less. The thickness T1 of the folded region E is more preferably 60 μm or greater and 2000 μm or less, and even more preferably 100 μm or greater and 1050 μm or less.

The thickness T1 of the folded region E described above is preferably a thickness approximately equal to the thickness T2 of the region F, [cathode+anode+two separators], where the cathode active material layers 12 are formed. Assuming the thickness T1 of the folded region E is approximately the thickness of the [cathode+anode+two separators], the thickness, when all the layers are stacked, the thickness of the region where the folded regions E are superposed and the thickness of the region where the active material layer-formed regions are superposed are approximately equal, warping of the cathode current collectors 11 between these regions is therefore suppressed, and the applied load can be reduced. Assuming that the thickness of the cathode 10 (the thickness T2 of the region F where the cathode active material layers 12 are formed) is 60 to 850 μm (preferably 100 to 600 μm), the thickness of the anode 20 (see FIG. 1) (the thickness of the region where the anode active material layers are formed) is 25 to 350 μm (preferably 35 to 250 μm), and the thickness of the separators 30 (see FIG. 1) is 10 to 200 μm (preferably 20 to 100 μm); the thickness of the [cathode+anode+two separators] will be 105 to 1600 μm (preferably 175 to 1050 μm). Consequently, it is also preferable for the thickness T1 of the folded region E to be 105 to 1600 μm (preferably 175 to 1050 μm).

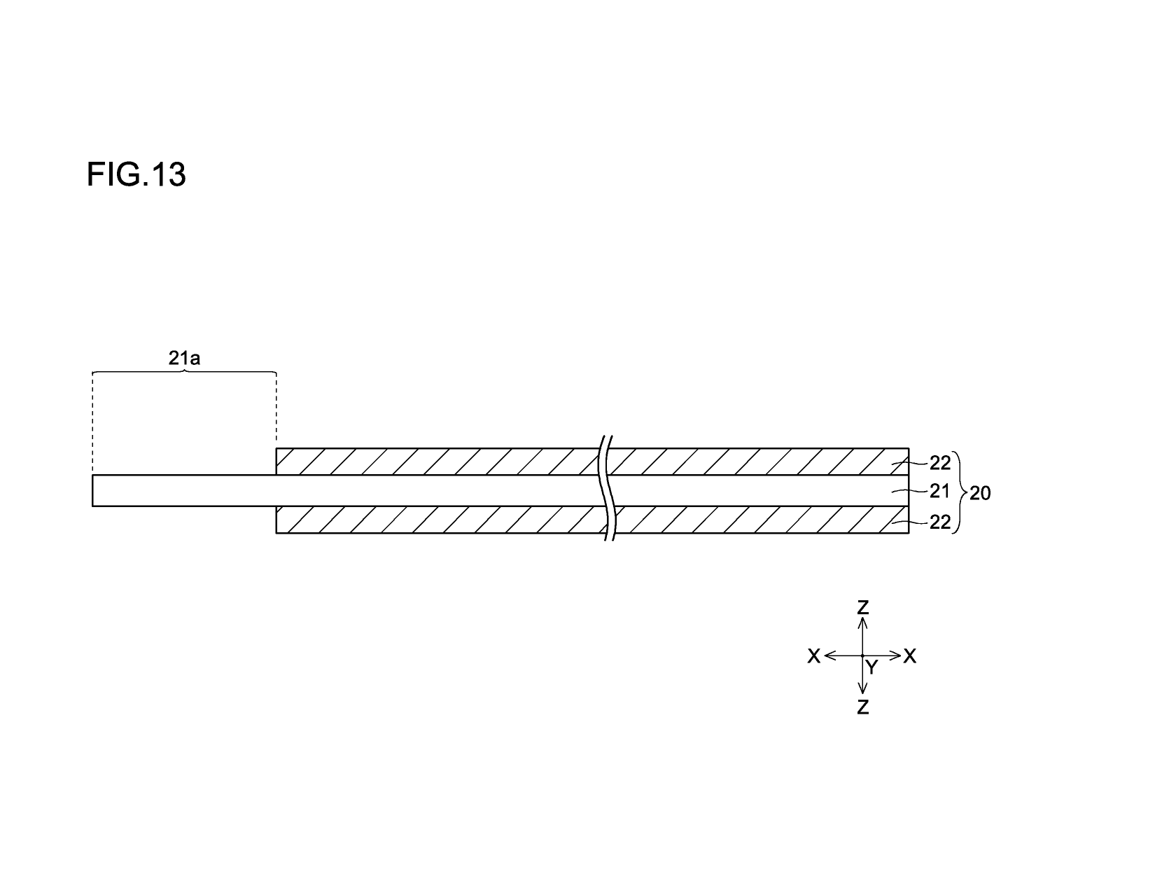

Each of the anodes 20 constituting the electrode group 50 has a configuration in which anode active material layers 22 are supported on both sides of an anode current collector 21, as shown in FIG. 13.

The anode current collector 21 has the function of collecting the currents of the anode active material layers 22.

In the first embodiment, the anode current collector 21 has a configuration that does not include a resin layer, unlike the cathode current collector 11 described above (see FIG. 5). Specifically, in the first embodiment, only the cathode current collector 11 (see FIG. 5) is configured into a multi-layered structure that includes a resin layer.

Specifically, the anode current collector 21 is configured from a metal foil of copper, nickel, stainless steel, iron, a nickel plating layer, or the like; or an alloy foil composed of an alloy of these metals, for example. The anode current collector 21 has a thickness of approximately 1 μm to approximately 100 μm (e.g., approximately 10 μm). A metal foil composed of copper or a copper alloy is preferable for the anode current collector 21 since it tends not to alloy with lithium, and the thickness thereof is preferably 4 μm or greater and 20 μm or less.

Instead of a foil, the anode current collector 21 described above may be in the form of a film, a sheet, a netting, a punched or expanded article, a lath, a porous body, a foamed body, a fiber cluster, or the like.

The anode active material layers 22 are configured including an anode active material that can that can occlude and discharge lithium ions. The anode active material is composed of a material that includes lithium, or a material that can occlude and discharge lithium, for example. To configure a high energy density cell, the electric potential for occluding/discharging lithium is preferably near the precipitation/dissolution electric potential of metal lithium. A prime example is natural graphite or synthetic graphite in the form of grains (in the form of flakes, clumps, fibers, whiskers, balls, ground grains, or the like). The anode active material may be synthetic graphite obtained by graphitization of mesocarbon microbeads, mesophase pitch powder, isotropic pitch powder, or the like. Graphite grains with amorphous carbon deposited on the surface can also be used. Furthermore, a lithium transition metal oxide, a lithium transition metal nitride, a transition metal oxide, silicon oxide, and the like can also be used. When lithium titanate, typified by Li₄Ti₅O₁₂, for example, is used as the lithium transition metal oxide, there is less deterioration of the anodes 20, and the life of the cell can therefore be prolonged.

The thickness of the anode active material layers 22 described above is preferably about 10 μm to 2 mm, and more preferably about 50 μm to 1 mm.

The configuration of the anode active material layers 22 described above is not particularly limited as long as it includes at least the anode active material. For example, other than the anode active material, the anode active material layers 22 may include an electrical conductor, a thickener, a binder, and other materials. The same electrical conductor, thickener, binder, and other materials as the cathode active material layers 12 can be used (those capable of being used in the cathode active material layers 12).

The anodes 20 described above are formed by mixing the anode active material, the electrical conductor, the thickener, and the binder, adding a suitable solvent to create a paste-form anode mixture, coating the surface of the anode current collector 21 with the mixture, drying the coating, and compressing the result to increase the electrode density as necessary, for example.

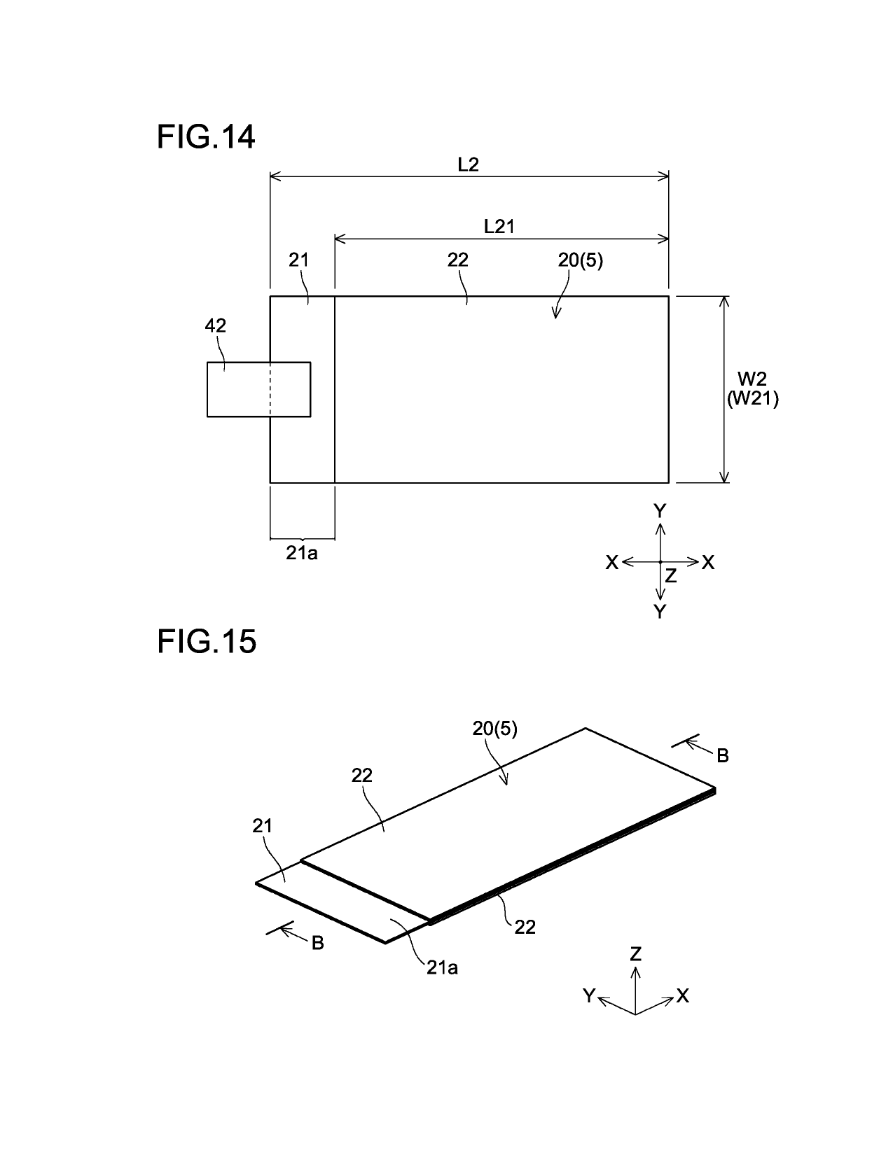

Each of the anodes 20 described above, shown in plan view, has a substantially rectangular shape as shown in FIG. 14, and is formed to be slightly larger than the cathodes 10 (see FIGS. 6 and 7). Specifically, in the first embodiment, each of the anodes 20 described above has a width W2 in the Y direction of approximately 110 mm, for example, and a length L2 in the X direction equal to the length L1 of the cathodes 10 (see FIG. 6) at approximately 150 mm, for example. The coated region (formed region) of the anode active material layer 22 has a width W21 in the Y direction equal to the width W2 of the anode 20 at approximately 110 mm, for example, and a length L21 in the X direction of approximately 140 mm, for example.

Each of the anodes 20 described above, similar to the cathodes 10, has a current collector exposed part 21a at one end in the X direction, in which the anode active material layer 22 is not formed and the surface of the anode current collector 21 is exposed, as shown in FIGS. 13 through 15. A tab electrode 42 (see FIG. 14) for extracting electric current to the exterior is electrically connected to the current collector exposed part 21a. The tab electrode 42 is formed into a shape approximately 30 mm in width and approximately 70 mm in length, the thickness being approximately 100 μm, for example, similar to the tab electrode 41 described above.

The separators 30 (see FIGS. 1 and 2) constituting the electrode group 50 can be appropriately selected from: electrically insulating synthetic resin fibers, glass fibers, natural fibers, or other nonwoven fabrics; woven fabrics; microporous films; or the like. Of these, polyethylene, polypropylene, polyester, aramid-based resins, cellulose-based resins, or another nonwoven fabric; and microporous films are preferable in terms of their consistency of quality and other characteristics. Particularly preferable are nonwoven fabrics composed of aramid-based resins, polyester-based resins, or cellulose-based resins; and microporous films.

The separators 30 preferably have a higher melting point than the resin layer 13 of the cathode current collector 11. For example, the separators 30 preferably have a thermal shrinkage of 1.0% or less at temperatures equal to or less than the melting point (may also be the heat distortion temperature (herein, heat distortion temperature<melting point)) of the resin layer 13 of the cathode current collector 11. The separators 30 are also preferably configured from a porous film of an aramid-based resin, a polyester-based resin, a cellulose-based resin, or the like, whose thermal shrinkage rate at 180° C. is 1.0% or less. The method for determining the thermal shrinkage rate of the separators 30 can be the same method as that of the resin layer 13 described above.

The thickness of the separators 30 is not particularly limited, but the thickness is preferably one at which the necessary amount of electrolytic solution can be held in, and is also preferably one at which short circuiting of the cathodes 10 and anodes 20 can be prevented. Specifically, the separators 30 can have a thickness of 10 μm to 1000 μm, for example. The thickness of the separators 30 is preferably about 10 to 200 μm, and more preferably about 20 to 100 μm. The material constituting the separators 30 preferably has an air permeability per unit surface area (1 cm²) of about 0.1 sec/cm³ to 500 sec/cm³ because a low cell internal resistance can be maintained and a strength sufficient to prevent cell internal short circuiting can be ensured.

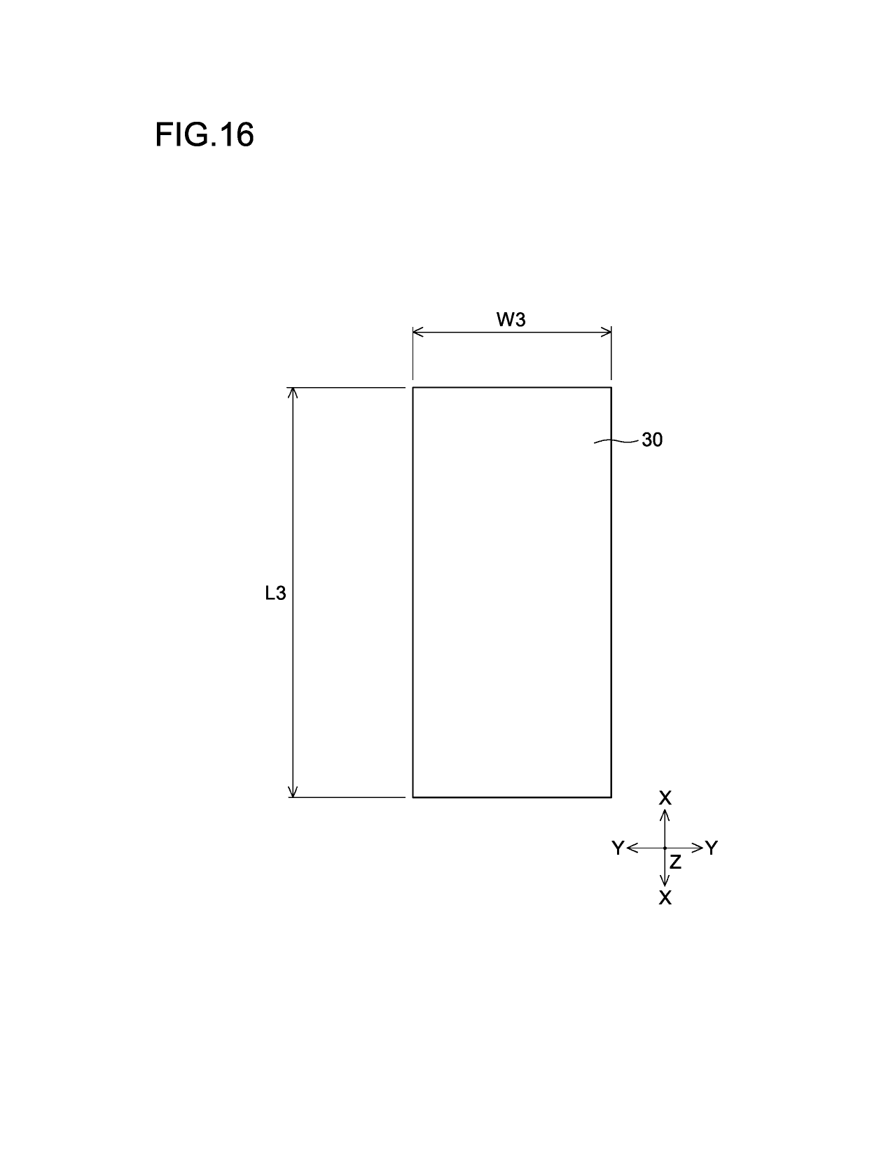

The separators 30 described above have a shape larger than the coated regions (the formed regions) of the cathode active material layers 12. Specifically, each of the separators 30 is formed into a rectangular shape, the width W3 in the Y direction being approximately 110 mm, for example, and the length L3 in the X direction being approximately 150 mm, for example, as shown in FIG. 16.

The cathodes 10 and the anodes 20 described above are placed so that the current collector exposed parts 11a of the cathodes 10 and the current collector exposed parts 21a of the anodes 20 are positioned on opposite sides from each other, and are stacked with the separators 30 interposed between the cathodes and anodes, as shown in FIGS. 1 and 2.

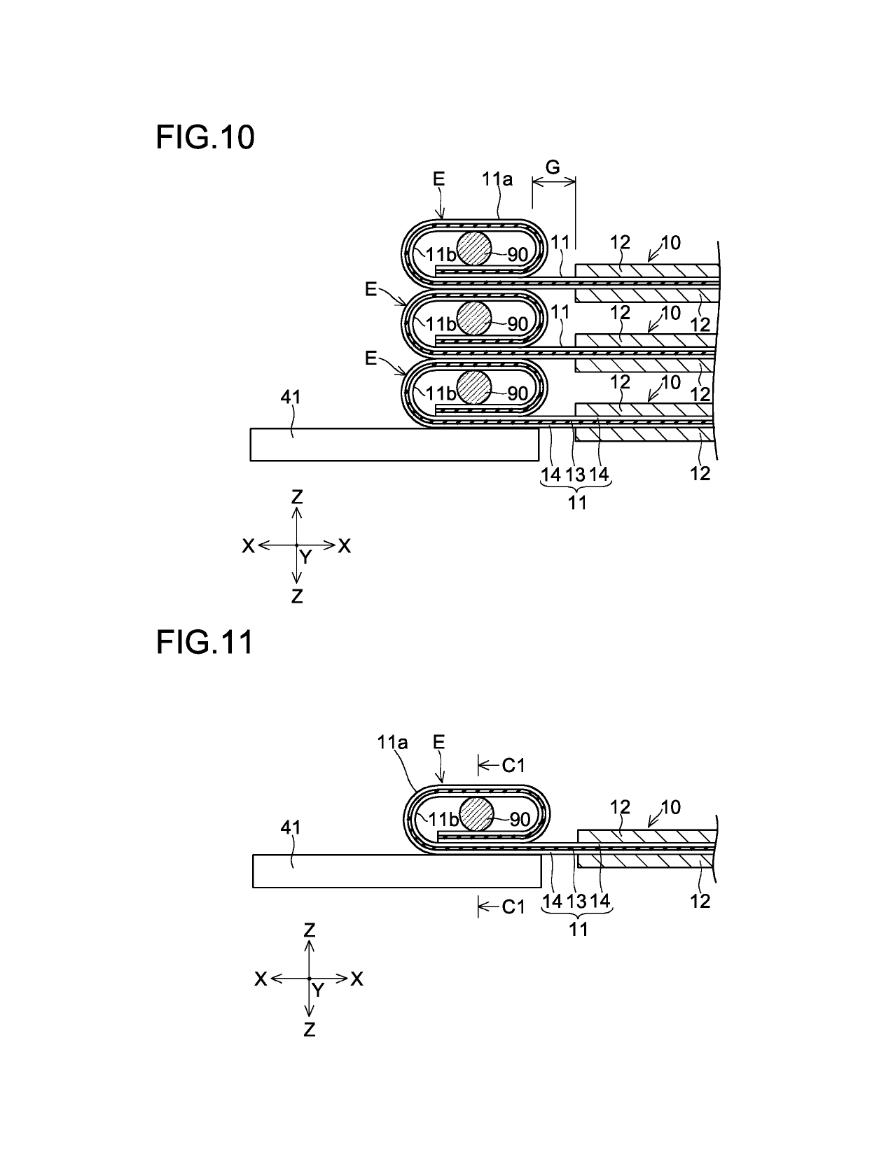

In the first embodiment, the plurality of cathodes 10 are stacked so that the current collector exposed parts (the uncoated parts) 11a line up, as shown in FIG. 10. The above-described tab electrode 41 is then fixed by welding to the outermost cathode 10 (the folded region E of the cathode current collector 11). Specifically, in the first embodiment, the tab electrode 41 is fixed by welding to the portion where the folded region E of the cathode 10 overlaps and the spacer 90 of the folded region E is placed. The tab electrode 41 described above is welded leaving a space inside the folded region E. The tab electrode 41 may also be fixed by welding to a cathode 10 other than the outermost cathode.

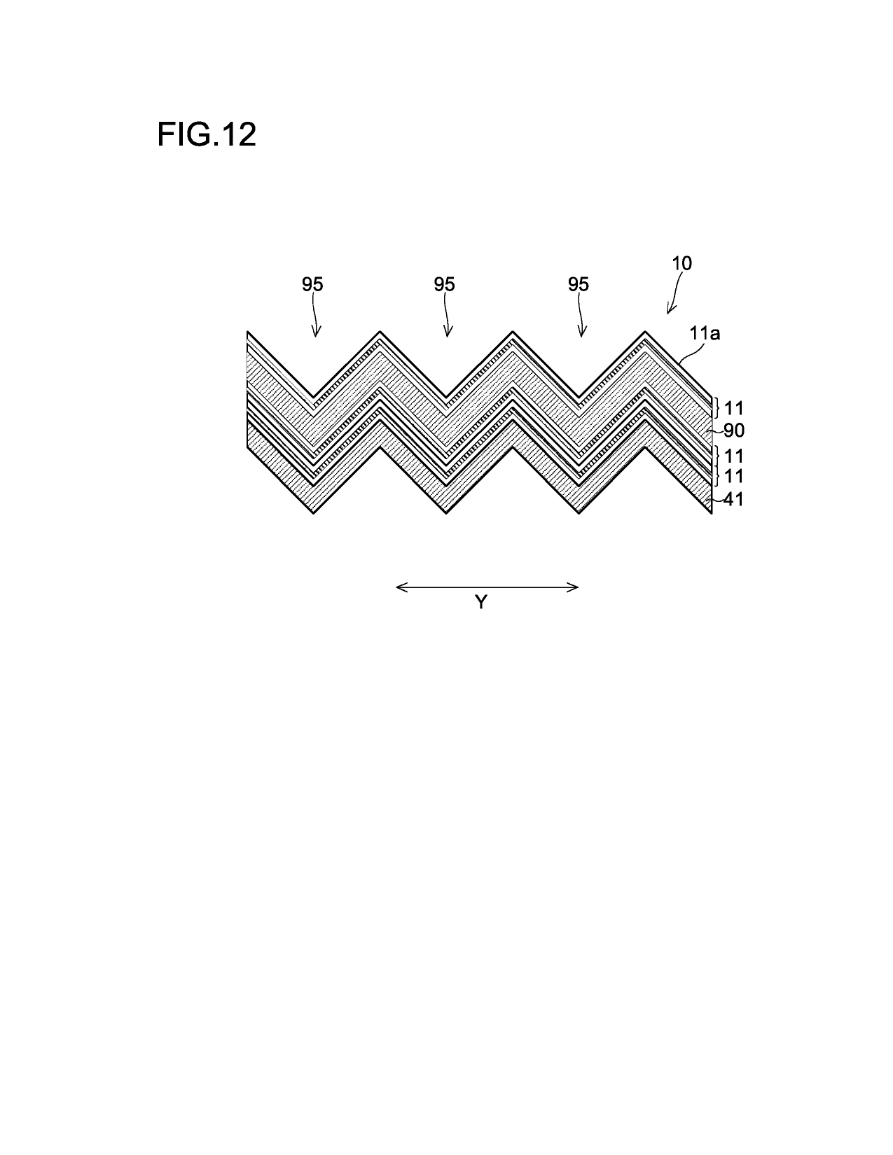

Furthermore, in the first embodiment, the tab electrode 41 described above is fixed by welding so as to mesh with the cathode current collector 11 as shown in FIGS. 11 and 12. Specifically, asperities 95 that mesh with each other are formed in the tab electrode 41 and the cathode current collectors 11 (the folded region E) as shown in FIG. 12, and the tab electrode is fixed by welding in the region of these asperities 95. The formation of the asperities 95 creates a synergistic effect combining the effect of meshing and the effect of increased contact surface area in the welded locations, and increases welding strength.

The asperities 95 described above can be formed easily by pressing, for example. In this case, the cathodes 10 are preferably stacked and pressed together with the tab electrode 41. With such a configuration, the tab electrode 41 described above can easily be meshed with the cathode current collector 11. When ultrasonic welding is used for the fixing by welding, for example, providing asperity shapes to the welding head makes it possible to form the asperities 95 described above when the stacked cathode current collectors 11 are pressurized by the welding head. In this case, the asperities 95 can be formed simultaneously with the fixing by welding. In FIGS. 11 and 12, part of a stacked cathode 10 is shown alone.

Due to the tab electrode 41 being welded in the folded region E of the current collector exposed part 11a, all of the stacked cathodes 10 (all of the electrically conductive layers 14) are in a state of being electrically connected with the tab electrode 41. The tab electrode 41 described above is fixed by welding to the substantially central part of the cathode current collector 11 (the cathode 10) in the width direction (the Y direction).

The thickness T1 of the folded region E is equal to or greater than the thickness T2 of the region F where the cathode active material layers 12 are formed as shown in FIG. 8. Therefore, as shown in FIG. 10, with the electrodes (the cathodes 10) stacked, there is little warping in the regions G between the folded regions E and the regions F (see FIG. 8) where the cathode active material layers 12 are formed. When each of the folded regions E has a thickness of approximately the cathode, anode, and two separators in combination as described above, the region G between the folded region E and the region F (see FIG. 8) where the cathode active material layers 12 are formed can be made flat (virtually parallel with the cathode active material layers 12), and warping can be further reduced.

The plurality of anodes 20 are stacked so that the current collector exposed parts 21a line up, similar to the cathodes 10, as shown in FIGS. 1 and 2. The above-described tab electrode 42 is then fixed by welding to the outermost anode 20 (the anode current collector 21). Similar to the case of the cathode, the tab electrode 42 may be fixed by welding to an anode 20 other than the outermost layer. All of the stacked anodes 20 are thereby in a state of being fixed by welding to the tab electrode 42 and electrically connected with the tab electrode 42. The tab electrode 42 described above is fixed by welding to the substantially central part in the width direction (Y direction) of the anode current collector 21 (the anode 20).

The welding of the tab electrodes 41 and 42 is preferably ultrasonic welding, but a technique other than ultrasonic welding, e.g., laser welding, resistance welding, spot welding, or the like, may be used. When the tab electrode 41 is welded to the cathode current collector 11 sandwiching the resin layer 13, laser welding, resistance welding, spot welding, and other means of bonding by adding heat have a risk of dissolving the resin layer 13. Therefore, ultrasonic welding which does not add heat is preferably used to weld the tab electrode 41 described above.

The tab electrode 41 connected to the cathode 10 is preferably configured from aluminum, and the tab electrode 42 connected to the anode 20 is preferably configured from copper. The tab electrodes 41 and 42 preferably use the same material as the current collectors, but may use a different material. Furthermore, the tab electrode 41 connected to the cathode 10 and the tab electrode 42 connected to the anode 20 may be either the same material or different materials. The tab electrodes 41 and 42 are preferably welded to the substantially central parts in the width direction of the cathode current collector 11 and the anode current collector 21 as described above, but may also be fixed by welding to regions other than the central parts.

The nonaqueous electrolytic solution enclosed along with the electrode group 50 in the external container 100 (see FIG. 2) is not particularly limited, but possible examples of the solvent include: ethylene carbonate (EC), propylene carbonate, butylene carbonate, diethyl carbonate (DEC), dimethyl carbonate, methylethyl carbonate, y-butyrolactone, and other esters; tetrahydrofuran, 2-methyl tetrahydrofuran, dioxane, dioxolane, diethyl ester, dimethoxyethane, diethoxyethane, methoxyethoxyethane, and other ethers; dimethyl sulfoxide, sulfolane, methyl sulfolane, acetonitrile, methyl formate, methyl acetate, and other polar solvents; and the like. These solvents may be used singly, or two or more solvents may be mixed and used as a mixed solvent.

The nonaqueous electrolytic solution may include an electrolytic supporting salt. Possible examples of the electrolytic supporting salt include LiClO₄, LiBF₄ (lithium borofluoride), LiPF₆ (lithium hexafluorophosphate), LiCF₃SO₃ (lithium trifluoromethanesulfonate), LiF (lithium fluoride), LiCl (lithium chloride), LiBr (lithium bromide), LiI (lithium iodide), LiAlCl₄ (lithium aluminate tetrachloride), and other lithium salts. These may be used singly, or mixtures of two or more may be used.

The concentration of the electrolytic supporting salt is not particularly limited, but is preferably 0.5 to 2.5 mol/L, and more preferably 1.0 to 2.2 mol/L. When the concentration of the electrolytic supporting salt is less than 0.5 mol/L, there is a risk that the concentration of the carrier that carries an electrical charge in the nonaqueous electrolytic solution will decrease and the resistance of the nonaqueous electrolytic solution will increase. When the concentration of the electrolytic supporting salt is higher than 2.5 mol/L, there is a risk that the degree of disassociation of the salt itself will decrease and the carrier concentration in the nonaqueous electrolytic solution will not increase.

The external container 100 enclosing the electrode group 50 is a large, flat, rectangular container, configured including an external canister 60 for accommodating the electrode group 50 and the like, and a sealing plate 70 for sealing up the external canister 60, as shown in FIGS. 1 and 3. The sealing plate 70 is also mounted on the external canister 60 accommodating the electrode group 50 by laser welding, for example.

The external canister 60 is formed by performing a deep drawing process or the like on a metal plate, for example, and is formed into a substantial box shape having a floor surface 61 and side walls 62. An opening 63 for inserting the electrode group 50 is also provided in one end of the external canister 60 (on the side opposite the floor surface 61), as shown in FIG. 1. The external canister 60 is formed into a size capable of accommodating the electrode group 50 so that the electrode surface thereof faces the floor surface 61.

In the external canister 60 described above, an electrode terminal 64 (e.g., a cathode terminal) is formed in a side wall 62 on one side in the X direction (a short side), and an electrode terminal 64 (e.g., an anode terminal) is formed in a side wall 62 on the other side in the X direction (a short side), as shown in FIGS. 1 and 3. A liquid inlet 65 through which the nonaqueous electrolytic solution is poured is formed in a side wall 62 of the external canister 60. This liquid inlet 65 is formed to a size of φ2 mm, for example. In proximity to the liquid inlet 65, a safety valve 66 for releasing the cell internal pressure is formed.

Furthermore, a bent part 67 is provided around the circumferential edge of the opening 63 of the external canister 60, and the sealing plate 70 is fixed by welding to the bent part 67.

The external canister 60 and the sealing plate 70 can be formed using a metal plate of iron, stainless steel, aluminum, or the like; or a steel plate of nickel plated over iron, for example. Iron is an inexpensive material and is therefore preferable in terms of cost, but to ensure long-term reliability, it is more preferable to use a metal plate composed of stainless steel, aluminum, or the like, or a steel plate of nickel plated over iron. The thickness of the metal plate can be approximately 0.4 mm to 1.2 mm, for example (approximately 1.0 mm, for example).

The electrode group 50 described above is accommodated in the external canister 60 so that the cathodes 10 and anodes 20 face the floor surface 61 of the external canister 60. In the accommodated electrode group 50, the current collector exposed parts 11a of the cathodes 10 and the current collector exposed parts 21a of the anodes 20 are electrically connected with the electrode terminal 64 of the external canister 60 via the tab electrodes 41 and 42.

The nonaqueous electrolytic solution is depressurized and poured in, for example, through the liquid inlet 65 after the opening 63 of the external canister 60 has been sealed by the sealing plate 70. After a metal ball (not shown) of virtually the same diameter as the liquid inlet 65 or a metal plate (not shown) slightly larger than the liquid inlet 65 has been placed in the liquid inlet 65, the liquid inlet 65 is sealed by resistance welding, laser welding, or the like.

Since the thickness Ti of the folded region E (see FIG. 8) is equal to or greater than the thickness T2 of the region F (see FIG. 8) where the cathode active material layers 12 are formed, the gap inside the external container 100 is reduced by the folded region E. Therefore, the electrode group 50 is not likely to vibrate inside the external container 100.

In the first embodiment, due to the folded region E where the current collector end part is folded at least twice in the same direction being provided in the cathode current collector 11 as described above, the electrically conductive layers 14 sandwiching the resin layer 13 can be electrically connected to each other in the folded region E. Therefore, electrical conduction among the electrodes can be established by forming the electrodes (the cathodes 10) using such cathode current collectors 11 even when current collectors having multi-layered structures are used. The tab electrode 41 can thereby be electrically connected to all of the electrodes. Additionally, the current collecting performance from the cathode current collectors 11 can be improved by forming gaps inside the folded regions E. Decreases in cell performance can thereby be suppressed, and the lithium ion secondary cell can be put into practical application with maximum performance.

In the first embodiment, due to the inside surfaces 11b of the current collector end part forming the above-described folded region E being separated from each other, i.e., due to the inside surfaces 11b of the current collector end part forming the folded region E being not entirely in contact with each other, the load applied to the folded portion of the cathode current collector 11 (the curved surface region of the folded region E) can be reduced when the current collector end part is folded. The occurrence of cracks, ruptures, and the like in the electrically conductive layers 14 of the cathode current collector 11 can thereby be suppressed. Specifically, the electrically conductive layers 14 of the cathode current collector 11 can be protected. As a result, it is possible to suppress the inconvenience of decreased electrical conductivity in the folded region E resulting from the occurrence of cracks, ruptures, and the like, and the current collecting performance in the cathode current collector 11 can therefore be improved.

In the first embodiment, a state in which the inside surfaces 11b of the current collector end part forming the folded region E are not entirely in contact with each other can easily be brought about by placing the spacer 90 contacting the inside surfaces 11b inside the folded region E. Additionally, the shape of such a folded region E can be kept by the spacer 90. The current collecting performance of the cathode current collector 11 can thereby be easily improved.

Due to the spacer 90 described above being configured from an electrical conductor having superior malleability, the malleability of the spacer 90 can be utilized to increase the contact surface area and the contact strength of the electrically conducting locations, the contact resistance between the electrically conductive layers sandwiching the insulation layer can thereby be reduced, and the current collecting performance of the current collector can therefore be effectively improved. Additionally, the spacer 90 can be easily fixed to the inside surfaces 11b (the electrically conductive layers) of the folded region E.

In the first embodiment, the welding strength can easily be improved by fixing the tab electrode 41 by welding to the folded region E of the cathode current collector 11. Vibration resistance can thereby be improved, and the deterioration over time of the cell performance can therefore be suppressed.

In the first embodiment, the ignition and other abnormal states can be prevented by forming the electrode (the cathode 10) using the current collector 11 having the resin layer 13, and safety can therefore be better improved.

In the first embodiment, the thickness T1 of the folded region E in the cathode 10 is greater than the thickness T2 of the region F where the active material layers 12 are formed, whereby warping can be reduced in the region G between the folded region E and the region F where the active material layers 12 are formed, and the load applied to the region G between the folded region E and the region F where the active material layers 12 are formed can therefore be reduced. The application of loads caused by vibration can also be impeded by reducing warping of the cathode 10, and vibration resistance can therefore be improved. Furthermore, the gap inside the external container 100 can be reduced by the folded region E. Specifically, the welded location is given thickness by the folded region E, and this portion can thereby be made to function as a spacer that fills up the gap in the external container 100. Therefore, the electrode group 50 can be impeded from vibrating within the external container 100. Therefore, this is another way to improve vibration resistance. Even when the gap inside the external container 100 is not completely filled up by the folded region E, the gap inside the external container 100 is made smaller by the presence of the folded region E described above. Therefore, vibration resistance can be improved even when the gap inside the external container 100 is not completely filled up.

In the first embodiment, welding strength can be increased by fixing the tab electrode 41 by welding so as to mesh with the cathode current collector 11. When the folded region E is folded in the cathode current collector 11, a risk is presented in regard to there being a decrease in welding strength. However, due to the tab electrode 41 being fixed by welding so as to mesh with the cathode current collector 11, the decreases in welding strength between the folded region E and the tab electrode 41 can be suppressed even when the folded region E is formed in the cathode current collector 11.

In the first embodiment, due to current collectors having a multi-layered structure being used as described above, when an abnormal amount of heat is generated in an overcharged state, a high-temperature state, or the like, for example, the resin layers 13 of the current collectors melt and the electrodes fail, and electric current (short circuit current) is therefore cut off Temperature increases in the cell interior can thereby be suppressed, and ignition and other abnormal states can therefore be prevented.

In the first embodiment, due to the resin layers 13 of the cathode current collectors 11 being configured from a thermoplastic resin whose thermal shrinkage rate at 120° C. is 1.5% or greater in any planar direction, when an abnormal amount of heat is generated in an overcharged state, a high-temperature state, or the like, for example, the electrodes can be made to readily fail. Ignition and other abnormal states can thereby be effectively prevented, and the safety of the lithium ion secondary cell can therefore be effectively improved.

In the first embodiment, due to the separators 30 being configured so as to have a thermal shrinkage rate of 1.0% or less at temperatures equal to or less than the melting point (may also be the heat distortion temperature (heat distortion temperature<melting point)) of the resin layers 13, the electrodes (the cathodes 10) can easily be made to readily fail when abnormal heat generation occurs in states such as overcharging or high temperatures. Specifically, due to the melting point (heat distortion temperature) of the separators 30 being higher than the melting point (heat distortion temperature) of the resin layers 13, the resin layers 13 constituting the cathode current collectors 11 can be fusion-cut before the shutdown function of the separators 30 activates. The electric current can thereby be cut off in two stages by the electric current cutoff effect of the resin layers 13 and the separators 30, and the safety of the lithium ion secondary cell can therefore be further improved.

Furthermore, when the thermal shrinkage rate of the above-described separators 30 at 180° C. is 1.0% or less, the occurrence of internal short circuiting originating from thermal shrinkage of the separators 30 (internal short circuiting of the cell occurring in the ends of the electrodes) can be suppressed in the case that an abnormal amount of heat is generated in an overcharged state or a high-temperature state, and the occurrence of sudden temperature increases can therefore be suppressed. As a result, the safety of the lithium ion secondary cell can be further improved. Furthermore, with such a configuration, melting and fluidization of the separators 30 can be suppressed even at a temperature of 180° C., and it is therefore possible to suppress the inconvenience of the holes of the separators 30 increasing in size because of melting and fluidization. Therefore, when the cell interior reaches 180° C., it is possible to suppress the inconvenience of larger areas of short circuiting in the cathodes and anodes originating from the increase in size of the holes of the separators 30, even when no failure has occurred in the electrodes (cathodes 10) for any reason.

### Second Embodiment

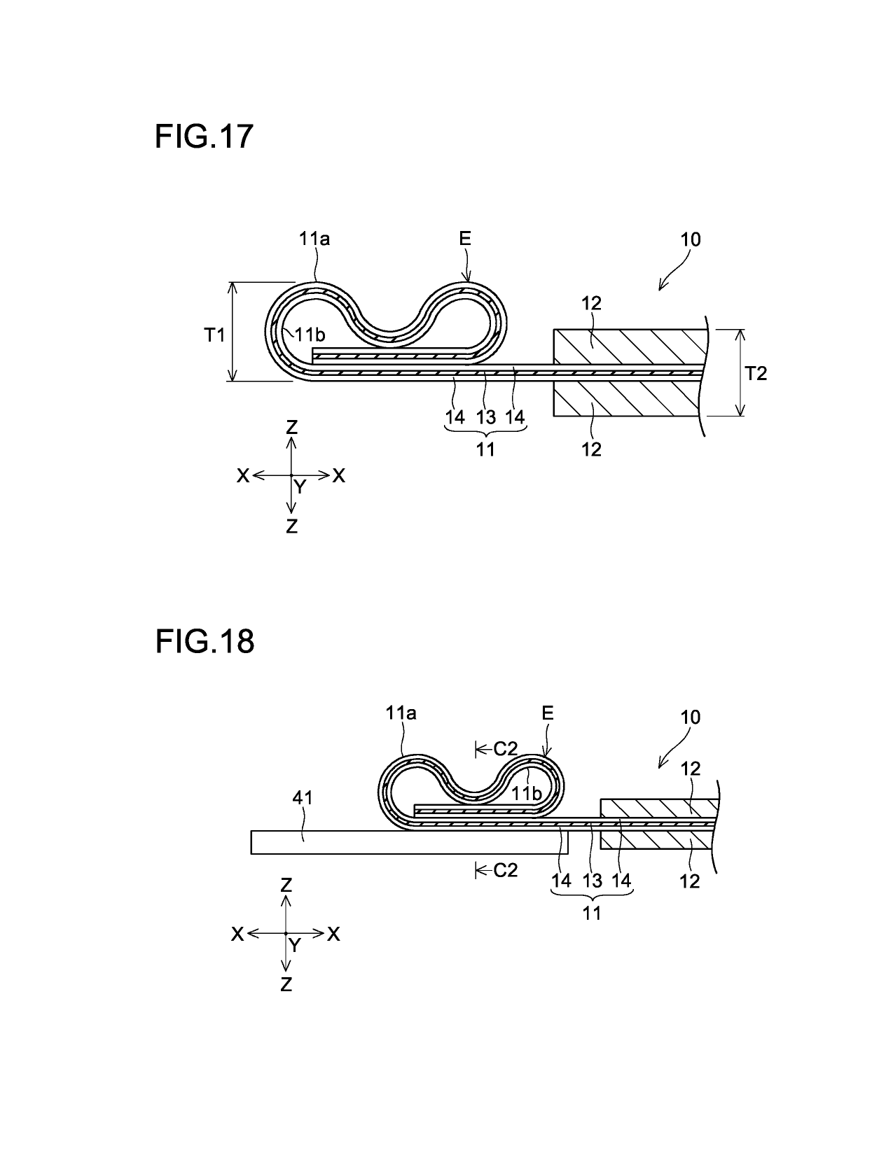

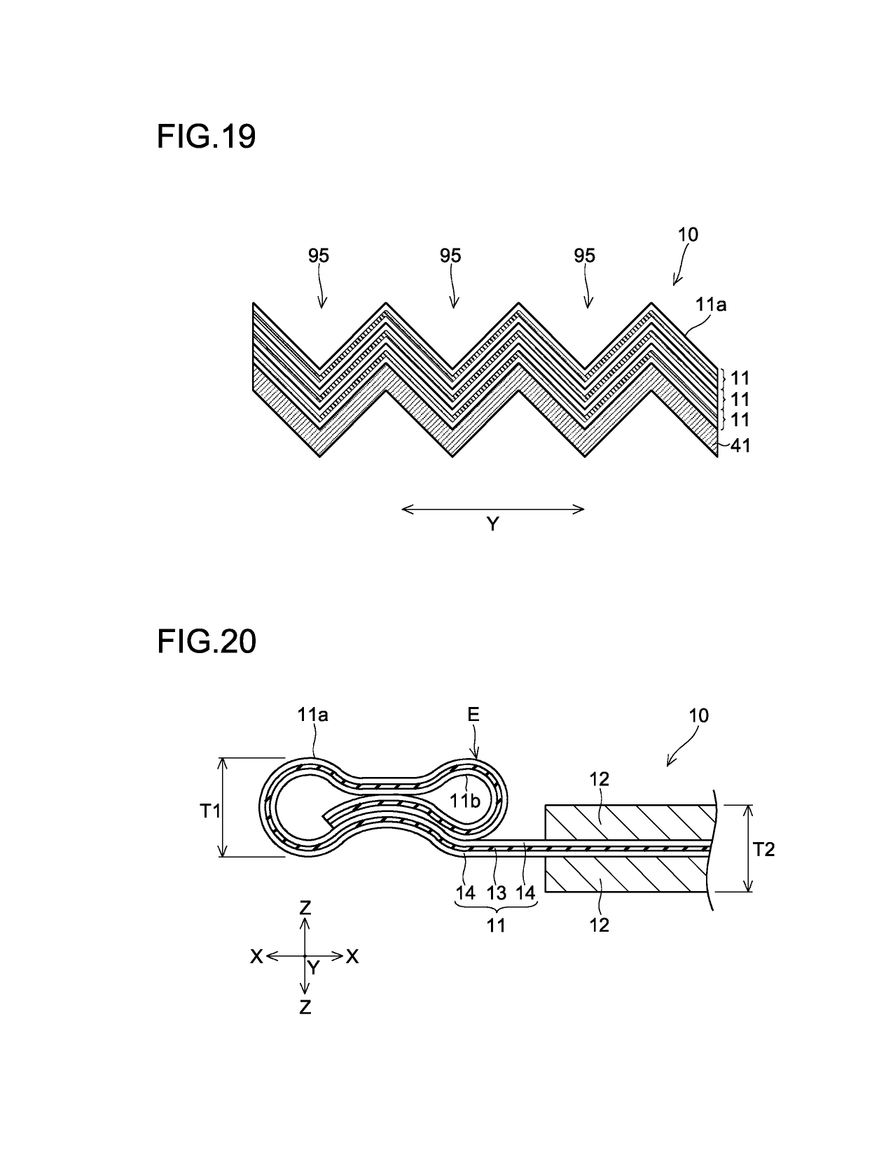

FIG. 17 is a schematic cross-sectional view showing an enlargement of part of a cathode current collector of the lithium ion secondary cell according to the second embodiment of the present invention. FIG. 18 is a schematic cross-sectional view showing the cathode current collector and the tab electrode in a state of having been fixed by welding in the second embodiment of the present invention. FIG. 19 is schematic cross-sectional view along line C2-C2 of FIG. 18. Next, the lithium ion secondary cell according to the second embodiment of the present invention will be described, referring to FIGS. 17 through 19. In these drawings, corresponding configurational elements are given the same symbols and redundant descriptions are appropriately omitted.

In the second embodiment, the inside surfaces 11b of the end part of the cathode current collector 11 forming the folded region E are not entirely in contact, but are partially in contact as shown in FIG. 17. Specifically, the top part of the folded region E deforms downward, the inside surfaces 11b of the end part of the cathode current collector 11 are in contact with each other in this portion. Therefore, in the second embodiment, two spaces are formed in the folded region E.

Welding is performed in order to keep the folded shape, and the shape may be kept.

The tab electrode 41 is fixed by welding so as to mesh with the cathode current collector 11 as shown in FIGS. 18 and 19. Specifically, asperities 95 that mesh with each other are formed in the tab electrode 41 and the cathode current collectors 11 (the folded region E) as shown in FIG. 19, and the tab electrode is fixed by welding in the region of these asperities 95. The formation of the asperities 95 creates a synergistic effect combining the effect of meshing and the effect of increased contact surface area in the welded locations, and increases welding strength.

The configuration of the second embodiment is otherwise identical to the first embodiment described above. The effects of the second embodiment are also identical to the first embodiment described above.

FIG. 20 is a schematic cross-sectional view showing an enlargement of part of the cathode current collector of the lithium ion secondary cell according to the first modification of the second embodiment. In the first modification of the second embodiment, the top part of the folded region E deforms downward, and the bottom part of the folded region E deforms upward, as shown in FIG. 20. The inside surfaces 11b of the end part of the cathode current collector 11 are in contact with each other in these deformed portions.

The configuration of the first modification is otherwise identical to the second embodiment described above. The effects of the first modification are also identical to the first and second embodiments described above.

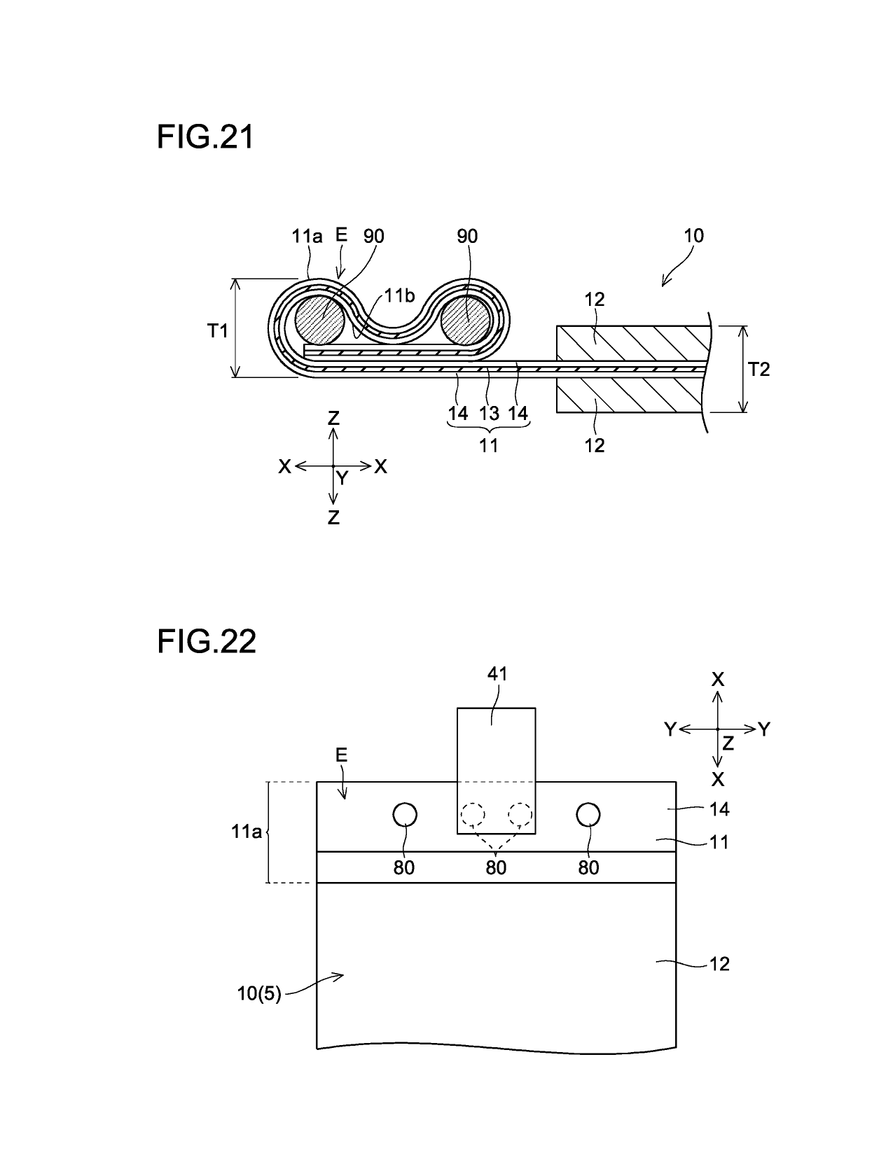

FIG. 21 is a schematic cross-sectional view showing an enlargement of part of the cathode current collector of the lithium ion secondary cell according to the second modification of the second embodiment. The second modification of the second embodiment has the same configuration as the second embodiment described above, except that spacers 90 are placed in the spaces of the folded region E, as shown in FIG. 21. In the second modification of the second embodiment, unlike the first embodiment described above, a tab electrode (not shown) is fixed by welding to the portion where the inside surfaces 11b of the end part of the cathode current collector 11 forming the folded region E are in contact with each other. Specifically, a tab electrode (not shown) is fixed by welding to a portion of the folded region E where spacers 90 are not placed. The tab electrode (not shown) can also be fixed by welding to the portion of the folded region E where the spacers 90 are placed, similar to the first embodiment described above.

The configuration of the second modification is otherwise identical to the second embodiment described above. The effects of the second modification are also identical to the first and second embodiments described above. The configuration of the first modification of the second embodiment described above can also have spacers 90 placed in the spaces of the folded region, similar to the second modification.

### EXAMPLE 1

In Example 1, in the configurations of the first and second embodiments described above, an electrically conductive sheet having a three-layer structure of an Al layer, a polyethylene resin layer, and an Al layer was used for the cathode current collector. A stacked lithium ion secondary cell was produced using a cathode current collector composed of this electrically conductive sheet.

The cathode current collector described above is a rectangular shape. A folded region was formed in the cathode having this cathode current collector by folding the end part (the uncoated parts of the cathode active material layers) twice in the same direction with a space inside. Cathodes were then stacked with the uncoated parts (the folded regions) lined up, and a current collecting member (a tab electrode) was welded in this location (the folded regions). The configuration of the Example 1 was otherwise identical to the first and second embodiments described above.

In the lithium ion secondary cell of Example 1 configured in this manner, welding the current collecting member with a space in the folded region of the current collector improved not only the current collecting performance of this location but improved vibration resistance as well, and reduced deterioration over time in cell performance.

### Third Embodiment

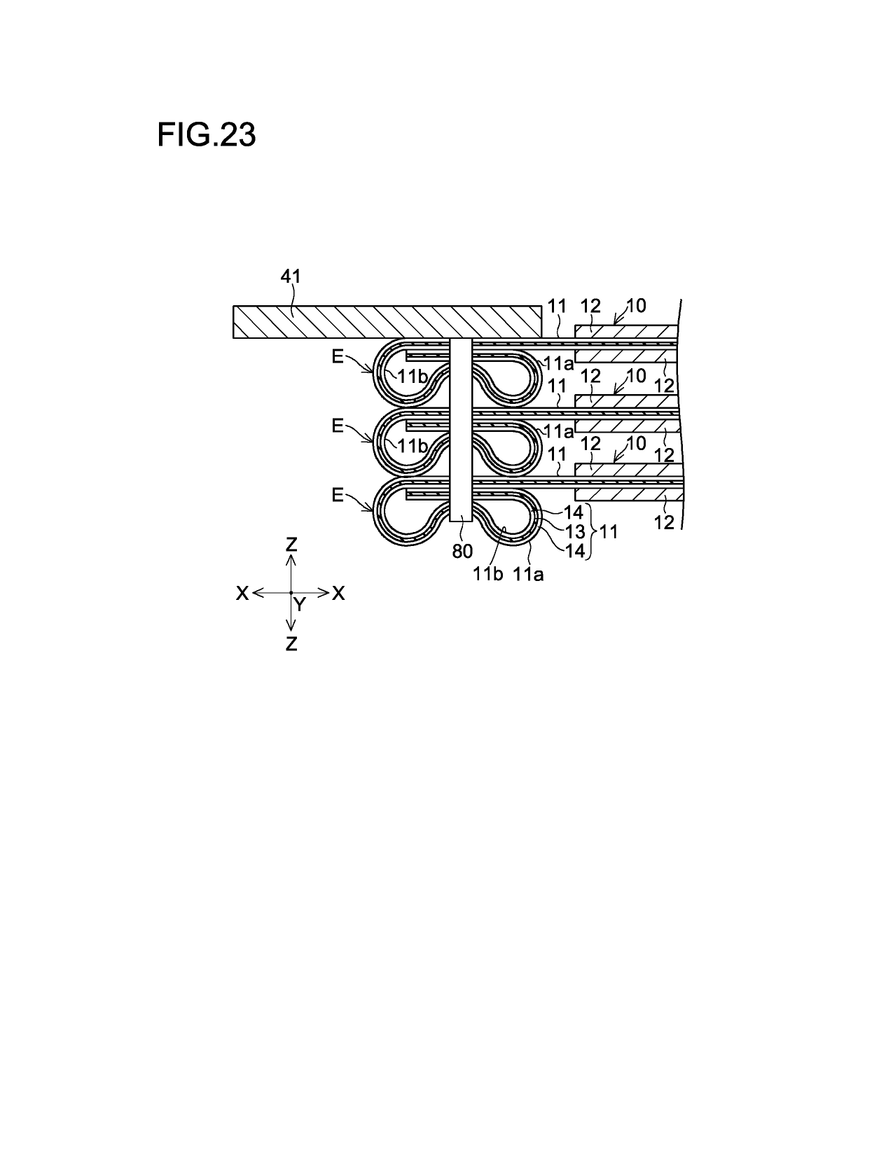

FIG. 22 is a plan view schematically showing part of a cathode used in the lithium ion secondary cell according to the third embodiment of the present invention. FIG. 23 is a cross-sectional view schematically showing part of the electrode group of the lithium ion secondary cell according to the third embodiment of the present invention. Next, the lithium ion secondary cell according to the third embodiment of the present invention will be described referring to FIGS. 22 and 23. In these drawings, corresponding configurational elements are given the same symbols and redundant descriptions are appropriately omitted.

The third embodiment has the same configuration as the second embodiment described above except for further comprising through-members 80 passing through the folded regions E of the cathode current collectors 11 in the thickness direction, as shown in FIGS. 22 and 23. The through-members 80 are configured from an electrically conductive material, and are passed consecutively through all of the stacked cathodes 10 (electrodes 5 of the same polarity). After the through-members 80 are passed through the folded regions E of the cathode current collectors 11, their distal end portions are crimped. The stacked cathodes 10 are thereby fixed by the through-members 80. The stacked cathodes 10 and the tab electrode 41 can all be fixed together by passing the through-members not only through the folded regions E of the cathode current collectors 11 but through the tab electrode 41 as well, and crimping the through-members.

The through-members 80 described above are preferably configured from aluminum or an aluminum alloy in terms of electrical conductivity, oxidation resistance, and other characteristics. The through-members 80 may be configured from a material other than aluminum or an aluminum alloy, e.g., titanium, stainless steel, nickel, or other metal materials; alloys thereof; or the like.

The through-members 80 are preferably provided to a plurality of locations in each of the current collector exposed parts 11 a of the cathode current collectors 11, as shown in FIG. 22. Due to the through-members 80 being provided (passed through) to a plurality of locations in the current collector exposed parts 11a in this manner, electric conduction between the electrodes (between the cathodes) improves because contact resistance between the cathodes decreases.

Asperities (not shown) are preferably provided to the surfaces of the through-members 80 described above. The asperities of the through-members 80 can be formed by filing, etching, casting, or the like, for example. The height of the asperities is preferably in a range of 0.1 μm to 5 mm, for example. The shape of the projections (convex portions) of the asperities is not particularly limited, and may be a trapezoidal shape, a three-sided pyramid shape, a semicylindrical shape (substantially semi-ellipsoidal shape), or another shape, for example.

The through-members 80 described above may have a needle shape such as that of a stapler needle (a staple), or a rivet-like columnar or cylindrical shape. In the case of rivet-like through-members 80, the through-holes through which the through-members 80 are inserted are preferably provided to the current collector exposed parts 11a (the folded regions E) of the cathode current collectors 11 in advance.

The configuration of the third embodiment is otherwise identical to the first and second embodiments described above.

In the third embodiment, due to the presence of the through-members 80 passing through the folded regions E of the cathode current collectors 11 in the thickness direction as described above, the electrically conductive layers 14 sandwiching the resin layers 13 can be electrically connected to each other by the through-members 80 as well. Electrical conduction among the electrodes can thereby be established, and decreases in cell performance can be further suppressed.

The effects of the third embodiment are otherwise identical to those of the first and second embodiments described above.

The embodiments heretofore disclosed are examples in all points and should not be construed as being by way of limitation. The scope of the present invention is shown by the claims rather than the above description of the embodiments, and the scope of the present invention includes meanings equivalent to the scope of the claims as well as all variations within the claims.

For example, in the first through third embodiments described above (including the modifications), an example was shown in which the present invention is applied to a lithium ion secondary cell which is one example of a nonaqueous secondary cell, but the present invention is not limited to this example; the present invention may also be applied to nonaqueous secondary cells other than a lithium ion secondary cell. The present invention can also be applied to nonaqueous secondary cells hereinafter developed.

In the first through third embodiments described above (including the modifications), an example was shown in which resin layers in film form were used as the resin layers (insulation layers) of the current collectors, but the present invention is not limited to this example; resin layers in a form other than a film, e.g., fibers, may be used. Possible examples of fibrous resin layers include layers composed of woven fabric, nonwoven fabric, or the like.

In the first through third embodiments described above (including the modifications), an example was shown in which the folded regions were formed by folding the current collector end parts twice in the same direction, but the present invention is not limited to this example; the present invention includes cases of folding at least three times in the same direction as well as cases of folding in the opposite direction after folding at least twice in the same direction.

In the first through third embodiments described above (including the modifications), an example was shown in which the cathodes and/or the anodes were formed using current collectors having three-layer structures, but the present invention is not limited to this example; the current collectors described above may be configured in multi-layered structures other than three-layer structures. For example, each of the current collectors may be configured in a multi-layered structure of three layers or more by forming a plating layer or the like on a metal foil.

In the first through third embodiments described above (including the modifications), an example was shown in which a flat rectangular container was used as the external container for accommodating the electrode group, but the present invention is not limited to this example; the shape of the external container need not be a flat rectangular shape. For example, the external container described above may be in the shape of a thin flat tube, a cylinder, a square tube, or the like. Considering that the cell could be used as a cell pack, the cell would preferably be thin and flat or rectangular. Furthermore, the external container described above may be an external container that uses a laminate sheet or the like, for example, instead of a metal canister.

In the first through third embodiments described above (including the modifications), an example was shown in which the anodes (the anode active material layers) were configured to be larger than the cathodes (the cathode active material layers), but the anodes (the anode active material layers) and the cathodes (the cathode active material layers) may be configured so as to be the same size. However, the anodes (the anode active material layers) are preferably configured so as to be larger than the cathodes (the cathode active material layers). With such a configuration, the formed regions of the cathode active material layers (the cathode active material regions) are covered by the formed regions of the anode active material layers (the anode active material regions) of larger surface area, whereby there can be a greater allowable range of stacking misalignment.

In the first through third embodiments described above (including the modifications), the configuration may have spacers placed in the folded regions of the current collectors, or the configuration may omit the spacers. For example, in the third embodiment described above, the configuration can have spacers placed in the folded regions of the current collectors. The shapes and other characteristics of the spacers described above are not particularly limited. In the first and second embodiments described above, an example was shown in which columnar spacers were used, but instead of columnar shapes, the spacers may be in the shape of ellipsoidal columns, for example. Spacers in the shape of prisms (of four or more sides, for example) can also be used.

In the first through third embodiments described above (including the modifications), the external container can be varied in many ways not only in its shape, but also in its size, structure, and other characteristics. The shape of the electrodes (cathodes, anodes), their dimensions, number used, and other characteristics can also be appropriately varied. Furthermore, the shape, dimensions, and other characteristics of the separators can also be appropriately varied. Various shapes can be used as the shape of the separators, e.g., a perfect square, an oblong square or other rectangle, a polygon, a circle, and the like.

Furthermore, in the first through third embodiments described above (including the modifications), an example was shown in which the spacers placed in the folded regions of the current collectors were configured from electrical conductors, but the present invention is not limited to this example; the spacers described above may be insulators having superior malleability. For example, the spacers described above may be configured from an insulating resin having superior malleability. When the spacers are configured from electrical conductors, an electrically conductive resin having superior malleability other than a metal material may be used, for example. The electrical conductors having superior malleability are more preferably configured from the same metal material as the members placed in the cell interior in particular.

In the first through third embodiments described above (including the modifications), an example was shown in which active material layers were formed on both sides of the current collectors, but the present invention is not limited to this example; an active material layer may be formed on only one side of each current collector. In an alternative configuration, a part of the electrode group includes electrodes (cathodes, anodes) in which an active material layer is formed on only one side of each current collector.

In the first through third embodiments described above (including the modifications), an example was shown in which a nonaqueous electrolytic solution was used as the electrolyte of the lithium ion secondary cell, but the present invention is not limited to this example; instead of a nonaqueous electrolytic solution, a gel electrolyte, a polymer solid electrolyte, an inorganic solid electrolyte, a molten salt, or the like, for example, may be used as the electrolyte.

In the first through third embodiments described above (including the modifications), an example was shown in which the current collectors on the cathode side (the cathode current collectors) were configured in multi-layered structures including the resin layers (the insulation layers), but the present invention is not limited to this example; the current collectors on the anode side (the anode current collectors) may also be configured in multi-layered structures including resin layers and electrically conductive layers. For example, both the cathodes and anodes may be formed using current collectors having multi-layered structures (three-layer structures), or either the cathodes or anodes alone may be formed using current collectors having multi-layered structures (three-layer structures). When either the cathodes or anodes alone are formed using current collectors having multi-layered structures (three-layer structures), those on the cathode side are preferably formed using current collectors having multi-layered structures (three-layer structures).

In cases in which the current collectors on the anode side are configured into multi-layered structures, the electrically conductive layers are preferably configured from copper or a copper alloy. Specifically, for example, copper or a copper alloy formed into a thickness of approximately 2 to 15 μm can be used as the electrically conductive layers. The electrically conductive layers of the anode current collectors may be configured from a material other than copper or a copper alloy, e.g., nickel, stainless steel, iron, alloys thereof, or the like. The resin layers of the anode current collectors can be the same as the resin layers of the cathode current collectors (that which can be used in the resin layers of the cathode current collectors), for example.

In cases in which the current collectors on the anode side are configured into multi-layered structures, folded regions in which the current collector end parts are folded two or more times in the same direction are preferably formed in the anodes, similar to the cathodes (the cathode current collectors) shown in the first through third embodiments described above (including the modifications).

In the second and third embodiments described above (including the modifications), an example was shown in which the inside surfaces of the current collector end parts forming the folded regions were configured so as to partially be in contact with each other, and in this case, there may be one, two, or more contact locations.

Embodiments obtained by appropriately combining the techniques disclosed above are also included within the technological scope of the present invention.

What is claimed is:

1. A current collector comprising:
a folded region in which an end part of a multi-layered structure having an insulation layer sandwiched by electrically conductive layers is folded at least twice in the same direction;
the electrically conductive layers sandwiching the insulation layer being electrically connected to each other in the folded region; and
inside surfaces of the end part of the current collector forming the folded region being either separated from each other or partially in contact with each other.

2. The current collector of claim 1, comprising:
a spacer contacting the inside surfaces of the folded region.

3. The current collector of claim 2;
the spacer being an electrical conductor.

4. A nonaqueous secondary cell comprising:
an electrode including the current collector of claim 1 and an active material layer formed in a region of the current collector excluding the folded region; and
a tab electrode electrically connected with the electrode;
the tab electrode being fixed by welding to the folded region of the current collector.

5. The nonaqueous secondary cell of claim 4;
the thickness of the folded region in the electrode being greater than the thickness of the region where the active material layer is formed.

6. The nonaqueous secondary cell of claim 4;
the tab electrode being fixed by welding so as to mesh with the current collector.

7. The nonaqueous secondary cell of claim 4, further comprising:
a through-member configured from an electrically conductive material and passing through the folded region of the current collector in the thickness direction.

8. The nonaqueous secondary cell of claim 4;
the electrode including a cathode and an anode; and
the cathode and/or the anode being formed using the current collector having a multi-layered structure.

9. The nonaqueous secondary cell of claim 8;
the electrically conductive layers of the current collector in the cathode being configured from aluminum when the cathode is formed using the current collector having a multi-layered structure; and
the electrically conductive layers of the current collector in the anode being configured from copper when the anode is formed using the current collector having a multi-layered structure.
